(19) United States
(12) Patent Application Publication
(10) Pub. No.: US 2013/0300111 A1
(43) Pub. Date: Nov. 14, 2013

(54) Connector Arrangement for Composite Pipe

(71) Applicant: Magma Global Limited, Portsmouth (GB)

(72) Inventors: Charles Alexander Tavner, West Sussex (GB); Martin Peter William Jones, Chichester (GB); Richard Damon Goodman Roberts, Hampshire (GB)

(21) Appl. No.: 13/940,594

(22) Filed: Jul. 12, 2013

Related U.S. Application Data
(63) Continuation of application No. PCT/GB2012/000027, filed on Jan. 13, 2012.

(30) Foreign Application Priority Data
Jan. 14, 2011 (GB) 1100585.7

(51) Int. Cl. F16L 47/00

(52) U.S. Cl. CPC F16L 47/00
USPC 285/335; 411/542

(57) ABSTRACT

A pipe connection apparatus or assembly 10 for use in applications in, e.g., the oil and gas industry, comprises an engagement member 20 adapted to engage an end region 41 of a pipe 40 when said pipe 40 is connected to a structure, wherein the engagement member 20 comprises a composite material 60 formed of at least a matrix 61 and one or more reinforcing fibres 62 embedded within the matrix 61, and the construction of the composite material 60 of the engagement member 20 is configured to accommodate the end region 41 of the pipe 40.

### CROSS-REFERENCE TO RELATED APPLICATIONS

This is a continuation of PCT/GB2012/000027, filed Jan. 13, 2012, which claims priority to Great Britain Application 1100585.7, filed Jan. 14, 2011, which are both incorporated herein by reference and to which priority is claimed.

### BACKGROUND

Composite pipes are used in many industries, such as in the oil and gas industry for the confined transportation of fluids and equipment associated with hydrocarbon recovery from a subterranean reservoir. For example, composite risers, flow lines and jumpers are known in the art.

Such pipes are manufactured in sections of various lengths, which sections may require connecting to secure one pipe section to another pipe section, or to another piece of equipment or apparatus such as a container, a tank, a manifold, a pump or the like.

Typically, connection between an end portion of a pipe and an end portion of another pipe or another member may occur by use of a connector. Such connectors may exert forces, e.g. compressive loads, on the connected portions of the pipes, which may cause damage to the pipe and/or failure of the connection. This may be of particular relevance when composite pipes are used, for example when a composite pipe possesses heterogeneous mechanical properties resulting from a particular orientation of the fibres within the matrix.

### SUMMARY

According to a first aspect there is provided a pipe connection apparatus comprising an engagement member configured to be engaged with an end region of a pipe and be interposed between the end region of the pipe and a structure to which said pipe is connected, wherein at least part of the engagement member comprises a composite material formed of at least a matrix and one or more reinforcing elements embedded within the matrix, and the construction of the composite material of the engagement member is configured to permit the engagement member to preferentially deform to accommodate the end region of the pipe.

The structure to which the pipe is or is to be connected may comprise a further pipe, equipment such as a container, a tank, a manifold, a pump or the like, at least part or all of the engagement member, and/or one or more further engagement members.

The engagement member may be interposed between the end region of the pipe and a separate structure, e.g. a further pipe, equipment such as a container, a tank, a manifold, a pump or the like, and/or one or more further engagement members.

The engagement member may be configured to contact or abut, e.g. sealably contact or abut, the end region of the pipe.

The engagement member may be configured to contact or abut, e.g. sealably contact or abut, the structure.

The engagement member may be configured to accommodate surface irregularities of the end region of the pipe.

The engagement member may be configured to accommodate a desired profile of an end face or end surface of the end region of the pipe, such as a designed or profiled end face or end surface.

The engagement member may be configured to accommodate preferential load distribution, such as uniform load distribution, e.g. within the end portion of the pipe.

The engagement member may be sacrificial, e.g. the engagement member may deform preferentially when the engagement member engages the end region of the pipe.

The engagement member may comprise or define a first side substantially facing the end region of the pipe, e.g. an end face or end surface thereof.

The engagement member may comprise or define a second side substantially facing the structure.

The second side of the engagement member may, in use, face an end region of a further pipe, e.g. at least part of an end face or end surface thereof.

The second side of the engagement member may, in use, face an end region of an auxiliary member, e.g. an auxiliary piece of equipment or apparatus such as a container, a tank, a manifold, a pump or the like.

The second side of the engagement member may, in use, face a first side of a further engagement member.

The engagement member may be secured against the pipe when said pipe is connected to the structure. For example, the engagement member may be secured by being clamped between the pipe and the structure.

The engagement member may be fixed to one or both of the pipe and the structure. The engagement member may be fixed to the pipe. The engagement member may be fixed to one or both of the pipe and structure by, for example, welding, fusing by melting and solidifying, mechanical connection, adhesive bonding or the like.

The engagement member may be directly interposed between the pipe and the structure.

The engagement member may be indirectly interposed between the pipe and the structure, e.g. a further engagement member may be provided between the engagement member and the pipe, and/or between the engagement member and the structure.

The pipe connection apparatus may comprise a plurality of engagement members, e.g. 1-5, e.g. 1 or 2 engagement members. It will be appreciated that the number of engagement members required may vary depending upon a number of parameters including pipe dimensions, pipe materials, internal pressure, external pressure, temperature, nature of the medium being transported, or the like.

The construction of the composite material of the engagement member may be configured such that at least some of the reinforcing elements, e.g. fibres, of the composite material of the engagement member may be predominantly oriented in a direction substantially transverse, e.g. substantially orthogonal, to an axis, e.g. a longitudinal axis, of the pipe, e.g. to a direction of the irregularities of the end face or end surface of the pipes. By such provision the construction of the composite material of the engagement member may be configured to preferentially deform to accommodate an engaging region of a structure, for example deform to comply with the pipe. In such an arrangement the matrix between the reinforcing elements may be deformed upon engagement, e.g. contact, between the engagement member and the end of the pipe and/or structure.

The composite material of the engagement member may deform upon engagement with the pipe end and/or structure.

The matrix material may deform upon engagement with the pipe end and/or structure.

At least some of the reinforcing elements may be unaffected, e.g. may not move or splay or may not be deformed or displaced, upon engagement with the pipe end. In such instance the engagement member may accommodate the end region of the pipe by deformation and/or compliance of the matrix material. The provision of the reinforcing elements may act to improve structural integrity of the engagement member, e.g. increased mechanical properties such as strength, modulus and the like.

At least some of the reinforcing elements may move, e.g. may deform, bend or splay within the matrix, e.g. relative to each other and/or relative to the matrix, upon engagement with the pipe end and/or structure. At least some of the reinforcing elements may move, e.g. may deform, bend or splay, preferentially transversely, e.g. orthogonally, upon engagement with the pipe, e.g. in a plane substantially transverse to an axis, e.g. to a longitudinal axis, of the pipe. The matrix material may also deform and/or comply to accommodate the end region of the pipe.

At least part of the pipe, e.g. at least part of the end region thereof, may comprise a composite material comprising a matrix and one or more reinforcing elements embedded within the matrix.

The whole or part of the engagement member and/or of the pipe may comprise, e.g. may be formed of, a composite material formed of at least a matrix and one or more reinforcing elements embedded within the matrix. For example, the engagement member may comprise a composite material on or near an outermost portion thereof, and/or may comprise a non-composite material, e.g. a polymeric or metallic material, on or near an innermost portion thereof. By such provision the risk of reinforcing elements entering or contaminating the fluid to be transported may reduced/eliminated.

The one or more reinforcing elements of the composite material of the connection portion and/or the pipe may comprise one or more reinforcing fibres, nanotubes, or the like.

Without wishing to be bound by theory, it is believed that a cause of failure in composite pipe ends may result from the inability of substantially axial reinforcing elements, e.g. fibres, at or near the end region of the pipe to locally deform to accommodate high local loads typically associated with regions of connection, which may be exacerbated by irregularities on or near the end surface of the pipe. This can result in significant load variations on or near the end surface of the pipe. A small area of the end surface and/or a limited number of substantially axial fibres of the pipe may locally bear high axial loading, causing local failure of the fibres of the composite material subjected to high axial loading. High axial loading may then be transferred to another small area of the end surface and/or a limited number of substantially axial fibres of the pipe end, which may result in cascading failure of small areas of the end surface and/or a limited number of substantially axial fibres of the pipe end.

The construction of the composite material of the engagement member may act to spread axial loading on the end region of the pipe over the end surface of the pipe engaged with, e.g. in contact or abutment with, the engagement member, thereby reducing the risk of failure of the pipe end.

The end face or end surface of the end region of the pipe may comprise surface irregularities which may be present by virtue of the reinforcing elements such as fibres, e.g. by virtue of fibre ends near the end surface or end face of the pipe. In such instance, upon engagement between the pipe and the engagement member, the composite material of the engagement member may deform so as to accommodate the surface irregularities of the pipe. This may assist to spread axial loading on the end region of the pipe over the end surface of the pipe engaged with, e.g. in contact or abutment with, the engagement member, thereby reducing the risk of failure of the pipe end. Surface irregularities may also result from the manufacture and/or processing, e.g. cutting, of the at least end region of the pipe and/or structure.

The end face or end surface of the end region of the pipe may be profiled according to a particular design. In such instance, upon engagement between the pipe and the engagement member, the reinforcing elements of the engagement member may splay, e.g. may deform, bend or move within the matrix, so as to accommodate the profile of the end face or end surface of the pipe.

At least part of the structure may comprise a composite material comprising a matrix and one or more reinforcing elements embedded within the matrix.

The end region of the pipe and/or the structure may be made of a non-composite material, e.g. metal. In such instance, upon engagement between the engagement member and the pipe, the composite material of the engagement member may deform so as to accommodate the end region of the pipe. In such instance, end surface or end face of the pipe may comprise surface irregularities resulting from the manufacture and/or processing, e.g. cutting, of the at least end region of the pipe and/or structure.

At least some of the reinforcing elements, e.g., fibres, of the composite material of the engagement member may be provided in a random manner within the matrix material. For example, the reinforcing elements may comprise chopped fibres mixed within the matrix material. Such an arrangement may permit the matrix material to deform, and any affected reinforcing elements to be splayed or displaced, upon engagement with the pipe end region, thus permitting said region to be accommodated.

At least some of the reinforcing elements, e.g., fibres, of the composite material of the engagement member may be provided in an ordered manner with a global or predominant direction of alignment within the matrix material. The ordered direction may be selected to permit the matrix material to deform, and any affected reinforcing elements to be splayed or displaced, upon engagement with the pipe end region, thus permitting said region to be accommodated.

At least some of the reinforcing elements, e.g. fibres, of the composite material of the engagement member may be predominantly oriented in a direction such that the engagement member, e.g. matrix thereof, may be capable of accommodating and/or sealably contacting or abutting the end region of the pipe and/or end region of the structure, and/or of substantially evenly applying compressive loads on the end face or end surface of end region of the pipe and/or end region of the structure, without causing damage to the end region of the pipe and/or end region of the structure. In such instance the composite material of the engagement member may deform upon engagement with the end region of the pipe and/or end region of the structure.

At least some of the reinforcing elements, e.g. fibres, of the composite material of the engagement member may be predominantly oriented in a direction substantially transverse, e.g. substantially orthogonal or perpendicular, to an axis of the pipe, e.g. to a direction of the irregularities of the end face or end surface of the pipe. Without wishing to be bound by any particular theory, it is believed that such configuration allows the irregularities to “fit” or be accommodated between the lengths of fibres running predominantly in a different direction, e.g. a substantially perpendicular direction, due to the resilient nature of the matrix. By such provision, exertion of substantial compressive loads, e.g. substantial local compressive loads, upon the reinforcing elements in an axial direction relative to the fibre orientation may be avoided or at least reduced, thus reducing potential damage to the connected parts.

The matrix material may deform upon engagement with the pipe end.

At least some of the reinforcing elements may be unaffected, e.g. may not move or splay or may not be deformed or displaced, upon engagement with the pipe end. In such instance the engagement member may accommodate the end region of the pipe by deformation and/or compliance of the matrix material. The provision of the reinforcing elements may act to improve structural integrity of the engagement member, e.g. increased mechanical properties such as strength, modulus and the like.

At least some of the reinforcing elements may be allowed or forced to move, e.g. to deform, bend or splay within the matrix, e.g. relative to each other and/or relative to the matrix, upon engagement with the end region of the pipe and/or end region of the structure. At least some of the reinforcing elements may move, e.g. may deform, bend or splay, preferentially transversely, e.g. orthogonally, upon engagement with the pipe, e.g. in a plane substantially transverse to an axis, e.g. to a longitudinal axis, of the pipe. The matrix material may also deform and/or comply to accommodate the end region of the pipe.

In one embodiment, the one or more reinforcing elements, e.g. fibres, of the composite material of the engagement member may be predominantly oriented in a substantially circumferential direction, e.g. in a direction substantially parallel to an inner and/or an outer circumference of the engagement member. In such instance the irregularities of the end region of the pipe and/or end region of the structure may extend in a substantially axial direction. The term “axial” will be understood herein as extending in a direction substantially parallel to a longitudinal axis of the end region of the pipe and/or end region of the structure.

In another embodiment, the one or more reinforcing elements, e.g. fibres, of the composite material of the engagement member may be predominantly oriented in a substantially radial direction, e.g. in a direction substantially radial relative to a longitudinal axis of the pipe. In such instance the profile and/or irregularities of the end region of the pipe and/or end region of the structure may extend in a substantially axial direction. The term “axial” will be understood herein as extending in a direction substantially parallel to a longitudinal axis of the end region of the pipe and/or end region of the structure.

In another embodiment, the reinforcing elements, e.g. fibres, of the composite material of the engagement member may be predominantly oriented in a substantially axial direction. In such instance the irregularities of the end region of the pipe and/or end region of the structure may extend in a substantially transverse, e.g. circumferential, direction.

The orientation/alignment of the reinforcing elements may be substantially constant throughout the matrix in an axial direction of the engagement member.

The shape and/or profile of the engagement member may match, e.g. may be substantially similar to, and/or may complement the shape and/or profile of the end region of the pipe and/or end region of the structure.

The engagement member, end region of the pipe, and/or end region of the structure may be substantially hollow, e.g. may comprise an inner bore or lumen. The shape and/or profile of the engagement member, end region of the pipe, and/or end region of the structure may be substantially tubular, e.g. circular or oval in cross-section. Alternatively, the shape and/or profile of the engagement member, end region of the pipe, and/or end region of the structure may be substantially rectilinear, e.g. square, hexagonal, etc, in cross-section.

An outer dimension, e.g. outer diameter or circumference, of the engagement member may be larger than an inner dimension, e.g. inner diameter or circumference, of the end region of the pipe and/or of the end region of the structure.

An outer dimension, e.g. outer diameter or circumference, of the engagement member may be larger than an outer dimension, e.g. outer diameter or circumference, of the end region of the pipe and/or of the end region of the structure.

An inner dimension, e.g. inner diameter or circumference, of the engagement member may be smaller than an outer dimension, e.g. outer diameter or circumference, of the end region of the pipe and/or of the end region of the structure.

An inner dimension, e.g. inner diameter or circumference, of the engagement member may be substantially similar to an inner dimension, e.g. inner diameter or circumference, of the end region of the pipe and/or of the end region of the structure. By such provision, flow of a medium, e.g. fluid, through the pipe connection apparatus may not be substantially affected by the provision of the engagement member.

The engagement member, end region of the pipe, and/or end region of the structure may be annular, and/or may comprise an annulus defined by a wall thickness of the engagement member, end region of the pipe, and/or end region of the structure. The terms “annular” and “annulus” are not to be understood as being strictly limited to concentric circles, but will be herein understood as including other shapes, e.g. oval, elliptic, etc.

In one embodiment, the size of the annulus of the engagement member may be smaller than the size of the annulus of the pipe and/or of the end region of the structure, i.e. an inner dimension, e.g. inner diameter or circumference, of the engagement member may be greater than an inner dimension, e.g. inner diameter or circumference, of the end region of the pipe and/or of the end region of the structure, and an outer dimension, e.g. outer diameter or circumference, of the engagement member may be smaller than an outer dimension, e.g. outer or circumference, of the end region of the pipe and/or of the end region of the structure.

In another embodiment, the size of the annulus of the engagement member may be substantially similar to the size of the annulus of the pipe and/or of the end region of the structure, i.e. an inner dimension, e.g. inner diameter or circumference, of the engagement member may be substantially similar to an inner dimension, e.g. inner diameter or circumference, of the end region of the pipe and/or of the end region of the structure, and an outer dimension, e.g. outer diameter or circumference, of the engagement member may be substantially similar to an outer dimension, e.g. outer diameter or circumference, of the end region of the pipe and/or of the end region of the structure.

In another embodiment, the size of the annulus of the engagement member may be greater than, e.g. marginally or substantially greater than, the size of the annulus of the pipe and/or of the end region of the structure, i.e. an outer dimension, e.g. outer diameter or circumference, of the engagement member may be greater than, e.g. marginally or substantially greater than, an outer dimension, e.g. outer diameter or circumference, of the end region of the pipe and/or of the end region of the structure.

The engagement member and or end region of the structure may be substantially solid. In such instance, the engagement member and or end region of the structure may act as a sealing member for the pipe.

The longitudinal thickness of the engagement member may be substantially uniform or constant, and/or may be relatively small, e.g. smaller than the inner diameter of the end region of the pipe and/or of the end region of the structure.

The longitudinal thickness of the engagement member may be in the range of 0.01 to 10 times, e.g. 0.01 to 5 times, e.g. 0.1 to 1 times the thickness of the end region of the pipe and/or of the end region of the structure.

The type and/or distribution of the reinforcing elements may be homogeneous throughout the matrix through a thickness, e.g. axial and/or radial thickness, of the engagement member and/or an end region of the pipe and/or an end region of the structure.

The type and/or distribution of the reinforcing elements may vary throughout the matrix, e.g. in a radial or axial direction, through a thickness of the engagement member and/or an end region of the pipe and/or an end region of the structure. By such provision physical properties of the engagement member and/or pipe and/or structure, e.g. strength, rigidity, or the like, may be adapted to suit the particular requirements at the location of the pipe connection, e.g. strength, rigidity, modulus, or the like.

The type and/or distribution of the reinforcing elements may vary throughout the matrix in an axial direction through an axial thickness of the engagement member and/or an end region of the pipe and/or an end region of the structure.

The engagement member may be configured to distribute and/or spread loading, e.g. axial loading, preferentially, e.g. substantially evenly, between the pipe end in contact with its first side such as a composite pipe end, and the structure in contact with its second side such as a metallic, e.g. steel, pipe end.

In one embodiment, the distribution of the reinforcing elements may vary throughout the matrix in an axial direction through an axial thickness of the engagement member and/or an end region of the pipe and/or an end region of the structure. By such provision, transitional and/or progressive mechanical properties, e.g. elasticity, of the engagement member may be achieved in an axial direction. For example, a portion of the engagement member at or near a surface of its first and/or second side may comprise a composite material having lower fibre density than the composite material of a portion of the engagement member distal from its surface(s), e.g. engagement surface(s). By such provision the composite material at or near an engaging surface(s) of the engagement member may have increased flexibility and/or ability to deform to accommodate or comply with the end region of the pipe and/or end region of the structure. In another embodiment, a portion of the engagement member at or near its first side or first engagement surface may have a density of reinforcing elements higher than at or near its second side or second engagement surface. By such provision the properties of the engagement member may be adapted to suit the mechanical properties, e.g. elasticity, of the pipe end/structure. For example, a first side of the engagement member engaging a composite pipe end may comprise a density of reinforcing elements different from, e.g. lower or higher than a second side of the engagement member engaging a non-composite pipe such as a steel pipe.

In another embodiment, a portion of the engagement member at or near its first side or first engagement surface may comprise a composite material having one or more reinforcing elements of a different type, e.g. having different properties such as stiffness, elasticity, strength or the like, from the one or more reinforcing elements of the composite material of a portion of the engagement member at or near its second side or second engagement surface. By such provision the properties of the engagement member may be adapted to suit the mechanical properties, e.g. elasticity, of the pipe end/structure. For example, a side of the engagement member engaging a composite pipe end may comprise a composite material comprising reinforcing fibres such as carbon fibres, and a side of the engagement member engaging a non-composite pipe such as a steel pipe may comprise a composite material comprising nanotubes such as carbon nanotubes.

In yet another embodiment, the engagement member may be profiled such that the area of engagement with the pipe end on its first side may be different from the area of engagement with the structure on its second side. For example, the engagement member may be configured to be tapered from is first side to its second side, or vice versa. In one embodiment, the engagement member may be configured such that its first side to engage a composite pipe may be larger than its second side to engage a non-composite pipe such as a steel pipe.

The distribution of the reinforcing elements may vary throughout the matrix in a radial direction through a radial thickness of the engagement member and/or an end region of the pipe and/or an end region of the structure. For example, the engagement member and/or an end region of the pipe and/or an end region of the structure may comprise a composite material having a density of reinforcing elements higher on or near an outermost portion thereof than on or near an innermost portion thereof. An inner region of the engagement member and/or an end region of the pipe and/or an end region of the structure may be devoid of reinforcing elements. By such provision the risk of reinforcing elements entering or contaminating the fluid to be transported may reduced/eliminated.

The engagement member may comprise at least one interengaging feature for receiving, interacting, containing or engaging with the end region of the pipe, and/or the end region of the structure.

The at least one interengaging feature may comprise, e.g. a recess, one or more rims, e.g. at least partially annular rims, and/or one or more individual protrusions. Such at least one interengaging feature may allow or assist in providing optimum position of the end region of the pipe in contact or in abutment with or against the first side of the engagement member, and or optimum position of the end region of the structure in contact or in abutment with or against the second side of the engagement member.

The at least one interengaging feature may engage with, contain, contact or abut an outer circumference of the end region of the pipe and/or end region of the structure.

The at least one interengaging feature may engage with, contain, contact or abut an inner circumference of the end region of the pipe and/or end region of the structure.

In one embodiment, the at least one interengaging feature may comprise a first substantially annular rim provided on a first and/or second side of the engagement member and extending substantially longitudinally, e.g. in a direction substantially facing the end region of the pipe and/or the end region of the structure.

The at least one interengaging feature may comprise a second substantially annular rim provided on a first and/or second side of the engagement member and extending substantially longitudinally, e.g. in a direction substantially facing the end region of the pipe and/or the end region of the structure.

The first side and/or second side of the engagement member may comprise first and second substantially annular rims. At least an end face of the end region of the pipe and/or the end region of the structure may engage with or fit within a groove which may be defined by the first and second substantially annular rims.

Without wishing to be bound by theory, it is believed that a cause of failure in composite pipe ends may result from the decompaction of the composite structure and/or splaying of fibres, e.g. in a substantially radial direction, at or near an end portion of the pipe due to substantial compressive loads, e.g. substantial local compressive loads, causing structural disintegration and/or decompaction of the composite material and/or breakdown of the polymer matrix. The provision of a first and/or second annular rim on the engagement member may act to prevent or at least reduce the risk of failure of the pipe end.

The whole or part of the engagement member may comprise, e.g. may be formed of, a composite material formed of at least a matrix and one or more reinforcing elements embedded within the matrix. For example, a main portion of the engagement member may be formed of a composite material, while at least part of the interengaging feature, e.g. a first and/or second substantially annular rim thereof, may comprise a non-composite material, e.g. a polymeric material such as an elastomer, a thermoplastic or a thermoset. By such provision properties, e.g. mechanical properties, of different portions of the engagement member may be tailored depending on the intended function of these portions.

The pipe connection apparatus may comprise at least one wrapping portion which may be provided on an outer and/or inner surface of the pipe, e.g. at or near the end region thereof. By such provision, the risk of failure of the composite pipe end due to decompaction of the composite material and/or splaying of the fibres of the composite material, e.g. in a substantially radial direction, may be reduced.

The wrapping portion may be provided on an outer and/or inner surface of the pipe prior to engagement with the engagement member.

The wrapping portion may be provided on an outer and/or inner surface of the pipe subsequent to engagement with the engagement member. In such instance, the wrapping portion may be provided on an outer and/or inner surface of the engagement member.

The end region of the pipe and/or engagement member may be profiled, e.g. may comprise a recess or indent, on an outer and/or inner surface of an end region thereof, which may be configured for accommodating the wrapping portion. By such provision, the outer diameter or perimeter of the end wrapping portion may be substantially similar to the outer diameter or perimeter of the pipe.

The wrapping portion may comprise a composite material formed of at least a matrix and one or more reinforcing elements embedded within the matrix.

The one or more fibres of the composite material of the wrapping portion may be predominantly oriented in a substantially circumferential direction, e.g. in a direction substantially parallel to an inner and/or an outer circumference of the engagement member and/or of the pipe.

The pipe connection apparatus, e.g. engagement member, may further comprise at least one sealing member, e.g. at least one compressive seal, which may be provided, e.g. on a first or second side thereof. By such provision, sealing property of the engagement member may be further improved.

The sealing member may be configured for contacting or abutting an end region of a pipe, an end region of a structure, or a end region of a further engagement member.

The sealing member may be provided, e.g. within a groove or recess of the engagement member, which may be provided on a first and/or second side thereof.

The sealing member may be provided, e.g. within a groove or recess of the end portion of the pipe, e.g. an end surface or end face thereof.

The sealing member may comprise an annular sealing member such as an ‘o-ring’ seal.

The engagement member may be configured to direct, restrict or confine a compressive force resulting from engagement of the engagement member with the pipe and/or structure, to a predetermined portion of the engagement member.

The engagement member may be configured to substantially reduce or restrict an area of the engaging surface between the engagement member and the pipe and/or structure, which may be exposed to pressure, e.g. to internal pressure from within the pipe, and/or to external pressure from outside the pipe.

The engagement member may comprise at least one dimple, e.g. at least one protrusion extending substantially annularly and/or longitudinally outwards relative to a first side and/or a second side thereof.

The engagement member may comprise at least one first dimple extending substantially annularly and/or longitudinally outwards relative to a first side thereof, and configured to contact or abut a end region of the pipe, e.g. and end face or end surface thereof.

The engagement member may comprise at least one second dimple extending substantially annularly and/or longitudinally outwards relative to a second side thereof, and configured to contact or abut an end region of the structure, e.g. an end face or end surface of a further pipe, or a first side of a further engagement member.

By such provision, the at least one dimple may provide a preferential engagement region on the engagement member which may act to preferentially bear high compressive loads, in use. This may be particularly desirable, e.g. if the connection apparatus and/or engagement member may be subject to, e.g. flexural or bending forces, in use.

The at least one dimple may be provided so as to distribute and/or spread loading, e.g. axial loading, preferentially, e.g. substantially evenly, between the pipe end in contact with its first side such as a composite pipe end, and the structure in contact with its second side such as a metallic, e.g. steel, pipe end. For example, a first side of the engagement member to engage a composite pipe may be devoid of a dimple, and a second side of the engagement member configured to engage a non-composite pipe of higher rigidity such as a steel pipe, may comprise one or more dimples.

The at least one dimple may act to reduce an area of the engaging surface between the engagement member and the pipe and/or structure, which may be exposed to pressure, e.g. to internal pressure from within the pipe, and/or to external pressure from outside the pipe. By such provision, the force exerted on the exposed area may be minimised.

The engagement member may be predominantly exposed to internal pressure from within the pipe and/or structure. In such instance the engagement member may comprise at least one first dimple which may be provided near an inner diameter or perimeter of the engagement member.

The engagement member may be predominantly exposed to external pressure from outside the pipe and/or structure. In such instance the engagement member may comprise at least one first dimple which may be provided near an outer diameter or perimeter of the engagement member.

The engagement member may comprise more than one dimple on its first side and/or second side. By such provision, the configuration of the engagement member may act to reduce an area of the engaging surface between the engagement member and the pipe and/or structure, which may be exposed to internal pressure from within the pipe, and to reduce an area of the engaging surface between the engagement member and the pipe and/or structure, which may be exposed to external pressure from outside the pipe.

A first and/or second side of the engagement member may comprise a profiled portion near an inner region and/or an outer region of the engagement member.

The profiled portion may extend towards an end region of the pipe/structure.

A thickness, e.g. axial thickness, of the profiled portion may be greater than the thickness, e.g. axial thickness, of the engagement member in a non-profiled portion thereof, e.g. a central portion thereof.

An inner and/or outer portion of the end region of the pipe/structure may be configured to substantially match, fit and/or complement the inner and/or outer profiled portion.

The engagement member may comprise an inner profiled portion which may be tapered from a central portion of the engagement member towards an innermost portion thereof. Internal pressure from within the pipe may act to compress the inner profiled portion of the engagement member against an inner portion of the pipe end. By such provision the profiled portion may act to increase sealing performance with the pipe end at or near an inner diameter thereof, which may be of particular interest when inner pressures from within the pipe are dominant. In such instance the inner profiled portion may comprise or form a pressure-activated seal. The inner profiled portion may also act to prevent or at least reduce the risk of failure of the pipe end through decompaction of the composite structure and/or splaying of fibres, e.g. in a substantially radial direction, at or near an inner end portion of the pipe due to substantial compressive loads, e.g. substantial local compressive loads, causing structural disintegration and/or decompaction of the composite material and/or breakdown of the polymer matrix.

The engagement member may comprise an outer profiled portion which may be tapered from a central portion of the engagement member towards an outermost portion thereof. External pressure from outside the pipe may act to compress the outer profiled portion of the engagement member against an outer portion of the pipe end. By such provision the profiled portion may act to increase sealing performance with the pipe end at or near an outer diameter thereof, which may be of particular interest when outer pressures from outside the pipe are dominant. In such instance the outer profiled portion may comprise or form a pressure-activated seal. The outer profiled portion may also act to prevent or at least reduce the risk of failure of the pipe end through decompaction of the composite structure and/or splaying of fibres, e.g. in a substantially radial direction, at or near an outer end portion of the pipe due to substantial compressive loads, e.g. substantial local compressive loads, causing structural disintegration and/or decompaction of the composite material and/or breakdown of the polymer matrix.

In one embodiment, the engagement member may comprise an inner profiled, e.g. tapered, portion near an inner region thereof, and an outer substantially annular rim near an outer region thereof. The outer substantially annular rim may act to prevent or at least reduce the risk of failure of the pipe end through decompaction of the composite structure and/or splaying of fibres, e.g. in a substantially radial direction, at or near an outer end region of the pipe due to substantial compressive loads, e.g. substantial local compressive loads, causing structural disintegration and/or decompaction of the composite material and/or breakdown of the polymer matrix.

In another embodiment, the engagement member may comprise an outer profiled, e.g. tapered, portion near an outer region thereof, and an inner substantially annular rim near an inner region thereof. The inner substantially annular rim may act to prevent or at least reduce the risk of failure of the pipe end through decompaction of the composite structure and/or splaying of fibres, e.g. in a substantially radial direction, at or near an inner end region of the pipe due to substantial compressive loads, e.g. substantial local compressive loads, causing structural disintegration and/or decompaction of the composite material and/or breakdown of the polymer matrix.

The inner profiled portion may be configured such that, in use, an innermost portion of the inner profiled portion first contacts an inner region of the pipe end/structure. By such provision, the innermost portion of the inner profiled portion may act as a preferential seal with the pipe end/structure. In such instance, the inner profiled portion may first contact the pipe end/structure near an inner diameter thereof. In use, upon further engagement with the pipe/structure, the inner profiled portion may deform so as to allow full engagement of the engagement member, e.g. contact or abutment, with the pipe end/structure.

The outer profiled portion may be configured such that, in use, an outermost portion of the outer profiled portion first contacts an outer region of the pipe end/structure. By such provision, the outermost portion of the outer profiled portion may act as a preferential seal with the pipe end/structure. In such instance, the outer profiled portion may first contact the pipe end/structure near an outer diameter thereof. In use, upon further engagement with the pipe/structure, the outer profiled portion may deform so as to allow full engagement of the engagement member, e.g. contact or abutment, with the pipe end/structure.

An inner region of the pipe may comprise a non-composite material, e.g. a material absent of reinforcing elements. The inner region of the pipe may comprise the same material as the matrix of the composite material forming an outer region of the pipe, e.g. a polymeric material such as polyether ether ketone (PEEK). In such instance, the inner region of the pipe may be capable of complying and/or deforming upon contact with the inner profiled portion of the engagement member so as to further improve sealing performance near an inner portion of the pipe and/or of the engagement member.

The pipe, e.g. the end region thereof, may comprise a composite material comprising a matrix material substantially constant throughout a thickness, e.g. a radial thickness, of the pipe. The pipe, e.g. the end region thereof, may comprise a composite material having a varying, e.g. increasing, density or amount of reinforcing elements from an inner region of the pipe to an outer region of the pipe. An inner region of the pipe may be devoid of reinforcing elements.

The pipe connection apparatus may be configured for use with or during a mechanical connection between said pipe and said structure, e.g. by use of bolts, screws, clips, clamps or the like.

The pipe connection apparatus may be configured for use with or during a permanent connection between said pipe and said structure, e.g. fused, welded, adhered, bonded or the like.

The engagement member may be formed integrally with the pipe, e.g. with an end portion thereof.

The engagement member may be formed integrally with the structure, e.g. with an end portion thereof.

The engagement member may be provided separately from the pipe and/or structure.

The engagement member may be secured permanently to the pipe and/or structure, e.g. to an end portion thereof, e.g. by melding, fusing, heat sealing, adhesive bonding, or the like.

The engagement member may be attached and/or connected to the pipe and/or structure, e.g. by mechanical connection such as screws, bolts, clips, clamps, or the like.

The pipe connection apparatus or assembly may further comprise at least one first connection member for securing an end region of the pipe to the engagement member, to at least one further engagement member, to an end region of the structure, and/or to at least one further second connection member.

The pipe connection apparatus or assembly may further comprise at least one second connection member for securing an end region of the structure to the engagement member, to at least one further engagement member, to an end region of the pipe, and/or to at least one first connection member.

The at least one first connection member may be configured to urge and/or bias the end region of the pipe against the engagement member, e.g. against a first side thereof.

The at least one second connection member may be configured to urge and/or bias the end region of the structure against the engagement member, e.g. against a second side thereof.

The at least one first connection member may comprise an attachment portion which may be configured for securing or attaching the at least one first connection member to the engagement member, to at least one further engagement member, to a end region of the structure, and/or to at least one second connection member, e.g. to an attachment portion thereof.

The at least one second connection member may comprise an attachment portion which may be configured for securing or attaching the at least one second connection member to the engagement member, to at least one further engagement member, to a end region of the pipe, and/or to at least one first connection member, e.g. to an attachment portion thereof.

In one embodiment, the attachment portion of the at least one first connection member may be configured to contact or abut the engagement member, e.g. an end region thereof. The attachment portion of the at least one second connection member may be configured to contact or abut the engagement member, e.g. a second portion thereof.

The first and or second connection member, e.g. a respective attachment portion thereof, may comprise one or more receiving portions, e.g. holes or apertures, arranged for receiving fixing members such as bolts, screws or the like.

The engagement member may comprise one or more receiving portions, e.g. holes or apertures, arranged for receiving fixing members such as bolts, screws or the like.

In use, the one or more receiving portions of the first connection member may be substantially aligned with the one or more receiving portions of the engagement member and/or of the second connection member. By such provision, the first connection member may be secured or attached to the engagement member and/or to the second connection member by provision of fixing members such as bolts, screws or the like.

The first connection member may be secured or attached to the engagement member and/or to the second connection member by provision of clips, clamps or the like.

The at least one first connection member may comprise a pipe connecting portion which may engage with or contact the pipe, e.g. the end region thereof, so as to urge and/or bias the end region of the pipe against the engagement member, e.g. against a first side thereof.

The at least one second connection member may comprise a member connecting portion which may engage with or contact the further pipe, e.g. the end region thereof, so as to urge and/or bias the end region of the further pipe against the engagement member, e.g. against a second side thereof.

The pipe, e.g. the end region thereof, may comprise at least one first anchor configured for engaging with or contacting the at least one pipe connecting portion of the at least one first connection member.

The at least one first anchor may comprise a raised portion which may extend circumferentially and/or radially outwards from an outer surface of the pipe.

The structure, e.g. the end region thereof, may comprise at least one second anchor configured for engaging with or contacting the pipe connecting portion of the at least one second connection member.

The at least one second anchor may comprise a raised portion which may extend circumferentially and/or radially outwards from an outer surface of the structure, e.g. of a further pipe.

In one embodiment, the at least one first and/or at least one second anchor may be tapered. The gradient of the taper may increase from a distal region to a proximal region relative to the engagement member.

Alternatively, the at least one first and/or at least one second anchor may have a substantially uniform profile in cross-section, e.g. in a longitudinal and/or radial cross-section, e.g. may comprise a circumferential ridge or groove, which may be e.g. square, part circular, or the like, in cross-section.

It will be appreciated that the at least one first and/or at least one second anchor may have a multitude of possible configurations. The at least one first and/or at least one second anchor may be configured to be substantially complementary in shape to the pipe connecting portion of the at least one first or second connection member, respectively.

At least part of the end region of the pipe, e.g. the at least one first anchor thereof, and/or at least part of the end region of the structure, e.g. the at least one second anchor thereof, may be formed using an elongate composite tape, roving, tow or the like which is manipulated, for example wound, to form said part. By such provision, the at least one first anchor of the pipe, and/or the at least one second anchor of the structure, may be integrally formed with the pipe or structure, respectively, e.g. during manufacture of the pipe and/or structure.

Alternatively, the at least one first anchor and/or the at least one second anchor may be preformed and/or provided on the pipe and/or structure, respectively, and may be secured thereto, e.g. by heat bonding, mechanical fixing or the like.

The connection apparatus may be configured to permit, in use, engagement of the pipe with the structure such that the end region of the pipe may terminate proximate the structure. By such provision, an area of connection between the pipe end and the structure may be reduced, and internal and/or external forces exerted on the connection apparatus may be reduced.

The connection apparatus may comprise an interface configured to permit, in use, engagement of the pipe with the structure such that the end region of the pipe and/or the structure may terminate proximate the interface.

The interface may be interposed between the end region of the pipe and/or the structure.

The engagement member may comprise at least part of the interface.

The end region of the pipe may abut or contact a first side of the engagement member.

The structure, e.g. an end region thereof, may abut or contact a second side of the engagement member. In such instance the pipe end and the structure may be engaged with each other via the engagement member. Thus, an area of connection between the pipe end and the structure may be reduced, and internal and/or external forces exerted on the connection apparatus may be reduced. By such provision, a simple seal may be formed between the pipe and the structure, allowing the end region of the pipe to be placed proximate the structure, while being capable of accommodating the end region of the pipe, accommodating preferential load distribution, such as uniform load distribution, e.g. within the end portion of the pipe.

The matrix material of the engagement member, at least end region of pipe and/or at least end region of structure, may comprise a polymer. The matrix material may comprise a thermoplastic component. The matrix material may comprise a thermoset component. The matrix material may comprise a polyaryl ether ketone, a polyaryl ketone, a polyether ketone (PEK), a polyether ether ketone (PEEK), a polycarbonate or the like, or any suitable combination thereof. The matrix material may comprise a polymeric resin, such as an epoxy resin or the like.

The one or more reinforcing elements of the composite material of the connection portion and/or the pipe may comprise one or more reinforcing fibres, nanotubes, or the like.

The reinforcing elements may comprise continuous or elongate fibres. The reinforcing fibres may comprise any one or combination of polymeric fibres, e.g. aramid fibres, or non-polymeric fibres, e.g. carbon, glass or basalt fibres or the like. The reinforcing fibres may comprise discontinuous fibres, e.g. chopped mat or fibres.

The reinforcing nanotubes may comprise, e.g. carbon nanotubes.

In some embodiments the composite material may comprise a matrix and fibres formed of similar or identical materials. For example, a composite material may comprise one or more reinforcing fibres which are formed of the same material as the matrix, albeit in a fibrous, drawn, elongate form or the like.

According to a second aspect there is provided a pipe connection apparatus or assembly for connecting an end region of a pipe to a structure, wherein the connection apparatus or assembly is configured to permit, in use, engagement of the pipe with the structure such that the end region of the pipe may terminate proximate the structure.

By such provision, an area of connection between the pipe end and the structure may be reduced, and internal and/or external forces exerted on the connection apparatus may be reduced.

The connection apparatus may comprise an interface configured to permit, in use, engagement of the pipe with the structure such that the end region of the pipe and/or the structure may terminate proximate the interface.

The interface may be interposed between the end region of the pipe and/or the structure.

The end region of the pipe may abut or contact a first side of the interface.

The structure, e.g. an end region thereof, may abut or contact a second side of the interface. In such instance the pipe end and the structure may be engaged with each other via the interface. Thus, an area of connection between the pipe end and the structure may be reduced, and internal and/or external forces exerted on the connection apparatus may be reduced. By such provision, a simple seal may be formed between the pipe and the structure, allowing the end region of the pipe to be placed proximate the structure.

The connection apparatus or assembly may comprise an engagement member adapted to engage the end region of the pipe when said pipe is connected to the structure.

At least part of the engagement member may comprise a composite material formed of at least a matrix and one or more reinforcing elements embedded within the matrix.

The construction of the composite material of the engagement member may be configured to accommodate the end region of the pipe.

The engagement member may comprise at least part of the interface.

Particular features of the engagement member described herein may apply to the connection apparatus or assembly according to a second aspect, and are therefore not repeated here for brevity.

According to a third aspect there is provided an engagement member adapted to engage an end region of a pipe and be interposed between the pipe and a structure to which the pipe is connected, wherein the engagement member comprises a composite material formed of at least a matrix and one or more reinforcing elements embedded within the matrix, and the construction of the composite material of the engagement member is configured to accommodate the end region of the pipe.

The engagement member may be configured to preferentially deform to accommodate the end of the pipe.

The structure may comprise a further pipe, equipment such as a container, a tank, a manifold, a pump or the like, at least part or all of the engagement member, and/or one or more further engagement members.

The engagement member may be interposed between the end region of the pipe and a separate structure, e.g. a further pipe, equipment such as a container, a tank, a manifold, a pump or the like, and/or one or more further engagement members.

The engagement member may be configured to contact or abut, e.g. sealably contact or abut, the end region of the pipe.

The engagement member may be configured to contact or abut, e.g. sealably contact or abut, the structure.

The engagement member may be configured to accommodate surface irregularities of the end region of the pipe.

The engagement member may be configured to accommodate a desired profile of an end face or end surface of the end region of the pipe, such as a designed or profiled end face or end surface.

The engagement member may be configured to accommodate preferential load distribution, such as uniform load distribution, e.g. within the end portion of the pipe.

The engagement member may be adapted for use in a pipe connection apparatus or assembly according to the first aspect of the present invention.

Particular features of the engagement member described herein may apply to the engagement member according to the third aspect, and are therefore not repeated here for brevity.

According to a fourth aspect there is provided a pipe assembly comprising:

a pipe comprising an end region; and

a connection apparatus or assembly comprising an engagement member configured to be engaged with an end region of a pipe and be interposed between the end region of the pipe and a structure to which said pipe is connected, wherein at least part of the engagement member comprises a composite material formed of at least a matrix and one or more reinforcing elements embedded within the matrix, and the construction of the composite material of the engagement member is configured to permit the engagement member to preferentially deform to accommodate the end region of the pipe.

The structure may comprise a further pipe, equipment such as a container, a tank, a manifold, a pump or the like, at least part or all of the engagement member, and/or one or more further engagement members.

The engagement member may be interposed between the end region of the pipe and a separate structure, e.g. a further pipe, equipment such as a container, a tank, a manifold, a pump or the like, and/or one or more further engagement members.

The engagement member may be configured to contact or abut, e.g. sealably contact or abut, the end region of the pipe.

The engagement member may be configured to contact or abut, e.g. sealably contact or abut, the structure.

The engagement member may be configured to accommodate surface irregularities of the end region of the pipe.

The engagement member may be configured to accommodate a desired profile of an end face or end surface of the end region of the pipe, such as a designed or profiled end face or end surface.

The engagement member may be configured to accommodate preferential load distribution, such as uniform load distribution, e.g. within the end portion of the pipe.

The pipe may comprise a composite material formed of at least a matrix and one or more reinforcing elements embedded within the matrix.

The engagement member may be adapted for use in a pipe connection apparatus or assembly according to the first aspect.

Particular features of the engagement member, pipe, and/or structure described herein may apply to the pipe assembly according to the fourth aspect, and are therefore not repeated here for brevity.

According to a fifth aspect there is provided a method of connecting an end region of a pipe to a structure, comprising providing an engagement member between an end region of a pipe and a structure, wherein the engagement member comprises a composite material formed of at least a matrix and one or more reinforcing elements embedded within the matrix, and the construction of the composite material of the engagement member is configured to accommodate the end region of the pipe.

The method may comprise providing the composite engagement member, e.g. a first side thereof, in contact or abutment with the end region of the pipe, e.g. an end face or end surface thereof.

The method may comprise providing the composite engagement member, e.g. a second side thereof, in contact or abutment with an end region of the structure, e.g. an end face or end surface thereof.

The structure may comprise a further pipe.

The method may comprise providing at least one wrapping portion on an outer and/or inner surface of the pipe prior to providing the composite engagement member.

The method may comprise providing at least one wrapping portion on an outer and/or inner surface of the pipe and/or of the engagement member subsequent to engagement with the engagement member.

The method may comprise profiling, e.g. providing a recess or indent on, the end region of the pipe and/or engagement member. By such provision the end region of the pipe and/or engagement member may be configured for accommodating the wrapping portion.

The method may further comprise attaching or securing the pipe and/or structure to the engagement member and/or to each other.

The method may comprise providing at least one first connection member for securing the end region of the pipe to the engagement member, to at least one further engagement member, to the structure, and/or to at least one second connection member.

The method may comprise securing the end region of the pipe to the engagement member, to at least one further engagement member, to the structure, and/or to at least one second connection member.

The method may comprise providing at least one second connection member for securing the structure to the engagement member, to at least one further engagement member, to the end region of the first member, and/or to at least one first connection member.

The method may comprise securing the structure to the engagement member, to at least one further engagement member, to the end region of the first member, and/or to at least one first connection member.

Particular features of the pipe, structure, engagement member, connection member, and/or wrapping portion described in connection with any other aspect may apply to method according to the fifth aspect, and are therefore not repeated here for brevity.

According to a sixth aspect there is provided a pipe connection apparatus or assembly comprising an engagement member adapted to engage an end region of a pipe when said pipe is connected to a structure;

wherein the engagement member comprises a composite material formed of at least a matrix and one or more reinforcing elements embedded within the matrix, wherein the one or more fibres of the composite material of the engagement member are predominantly oriented in a substantially circumferential direction,

and wherein the construction of the composite material of the engagement member is configured to accommodate the end region of the pipe.

The engagement member may be configured to preferentially deform to accommodate the end region of the pipe.

The end region of the pipe may comprise a composite material formed of at least a matrix and one or more reinforcing elements embedded within the matrix.

The one or more fibres of the end region of the pipe may be predominantly oriented in a substantially axial direction.

Particular features of the pipe, structure, and/or engagement member described in connection with any other aspect may apply to the pipe connection apparatus or assembly according to the sixth aspect, and are therefore not repeated here for brevity.

According to a seventh aspect there is provided a containment member configured for at least radially containing an end region of a pipe.

The containment member may be configured to radially contain an outer surface and/or an inner surface of the end region of the pipe.

Without wishing to be bound by theory, it is believed that a cause of failure in composite pipe ends may result from the decompaction of the composite structure and/or splaying of fibres, e.g. in a substantially radial direction, at or near an end portion of the pipe due to substantial compressive loads, e.g. substantial local compressive loads, causing structural disintegration and/or decompaction of the composite material and/or breakdown of the polymer matrix. The provision of a containment member may act to prevent or at least reduce the risk of failure of the pipe end.

The containment member may comprise at least part of an engagement member adapted to engage an end region of a pipe when said pipe is connected to a structure.

The construction of the composite material of the engagement member is configured to accommodate the end region of the pipe.

The engagement member may comprise at least one interengaging feature for receiving, interacting, or engaging with the end region of the pipe, and/or the end region of the structure.

The interengaging feature may comprise the containment member.

The containment member may comprise at least one wrapping portion which may be provided on an outer and/or inner surface of the pipe, e.g. at or near the end region thereof, and/or an outer and/or inner surface of the engagement member. By such provision, the risk of failure of the composite pipe end due to decompaction of the composite material and/or splaying of the fibres of the composite material, e.g. in a substantially radial direction, may be reduced.

Particular features of the pipe, structure, engagement member, interengaging feature, and/or wrapping portion described in connection with any other aspect may apply to the containment member according to the seventh aspect, and are therefore not repeated here for brevity.

According to an eighth aspect there is provided a pipe assembly comprising:

a pipe comprising an end region; and

a pipe connection apparatus or assembly according to a sixth aspect of the present invention, and/or a containment member according to a seventh aspect of the present invention.

Particular features of the pipe, pipe connection apparatus or assembly, and/or containment member according to any other aspect may apply to the pipe assembly according to the eighth aspect, and are therefore not repeated here for brevity.

According to a ninth aspect there is provided a pipe connection apparatus or assembly comprising an engagement member adapted to engage an end region of a pipe when said pipe is connected to a structure, wherein the construction of the composite material of the engagement member is configured to accommodate the end region of the pipe.

The engagement member may be configured to preferentially deform to accommodate the end region of the pipe.

The engagement member may comprise a resilient material, e.g. a polymeric material such as an elastomer, a thermoplastic, or a thermoset (thermosetting plastic).

The engagement member may comprise a composite material formed of at least a matrix and one or more reinforcing elements embedded within the matrix.

Particular features of the engagement member described above in connection with any other aspect may apply to the pipe connection apparatus or assembly according to the ninth aspect, and are therefore not repeated here for brevity.

In one or more of the aspects defined above the pipe connection apparatus, pipe and/or structure may be configured for use above the ground, e.g. in a chemical plant. The pipe connection apparatus, pipe and/or structure may be configured for use at least partially buried. The pipe connection apparatus, pipe and/or structure may be configured for use in a subterranean environment. The pipe connection apparatus, pipe and/or structure may be configured for use in a subsea location.

The pipe connection apparatus, pipe and/or structure may be configured for use as part of, for example, a riser, such as a vertical riser, catenary riser or the like, a flow line, a jumper or the like, or any combination thereof. The pipe connection apparatus, pipe and/or structure may be configured for use in transporting a fluid, providing a confined conduit for tooling or the like, such as may be used in subterranean wellbore drilling operations, completion operations, intervention operations and the like.

The pipe connection apparatus, pipe and/or structure may be configured for use in transporting product associated with the extraction of hydrocarbons from subsea reservoirs, including accommodating the flow of hydrocarbons, carbon dioxide, water, other chemicals, solid matter, fluid and gas mixes and the like.

The pipe connection apparatus, pipe and/or structure may be configured for use in carbon dioxide or other gas sequestration.

It should be understood that although terms such as “circumferential” and “radial” are used herein, these and similar terms are not intended to limit the pipe(s) to being circular in cross-section. Instead, the pipe(s) may be of any cross-sectional shape, such as oval, rectilinear or the like, and a circumferential segment may be considered to be a segment or sector of a perimeter of the pipe(s).

Other aspect may relate to a pipe such as a composite pipe, a pipe connector or the like, comprising one or more anchors for establishing anchor or load bearing point(s) for mechanical connection.

### BRIEF DESCRIPTION OF THE DRAWINGS

These and other aspects of the present invention will now be described, by way of example only, with reference to the accompanying drawings, in which:

FIG. 1 is a longitudinal cross-sectional view of a pipe assembly in accordance with an embodiment of one or more aspects, showing an enlarged insert of a connection region between a pipe and an engagement member of the pipe connection apparatus or assembly;

FIG. 2 is a longitudinal cross-sectional view of an alternative embodiment of the pipe assembly of FIG. 1, showing an enlarged insert of a second side of the engagement member of the pipe connection apparatus;

FIG. 3 is a longitudinal cross-sectional view of an alternative embodiment of the pipe assembly of FIG. 1, showing an enlarged insert of a second side of the engagement member of the pipe connection apparatus;

FIG. 4 is a longitudinal cross-sectional view of an alternative embodiment of the pipe assembly of FIG. 1, showing an enlarged insert of a connection region between the pipe and the engagement member of the connection apparatus;

FIG. 5 is a longitudinal cross-sectional view of an alternative embodiment of the pipe assembly of FIG. 1, showing connection members for connecting the pipe and the engagement member;

FIG. 6 is a longitudinal side view of a pipe end of the pipe assembly of FIG. 1;

FIG. 7 is a longitudinal cross-sectional view of an alternative embodiment of a pipe of the pipe assembly of FIG. 1, showing connection members for connecting the pipe and the engagement member;

FIG. 8a is a longitudinal cross-sectional view of an alternative embodiment of a pipe end of the pipe assembly of FIG. 1;

FIG. 8b is a longitudinal cross-sectional view of an alternative embodiment of the pipe end of FIG. 8a;

FIG. 8c is a longitudinal cross-sectional view of an alternative embodiment of the pipe end of FIG. 8a;

FIG. 9a is a partial longitudinal cross-sectional view of an upper section of an alternative embodiment of a pipe end of the pipe assembly of FIG. 1;

FIG. 9b is a partial longitudinal cross-sectional view of an upper section of an alternative embodiment of the pipe end of FIG. 9a;

FIG. 9c is a partial longitudinal cross-sectional view of an upper section of an alternative embodiment of the pipe end of FIG. 9a;

FIG. 10 is a partial longitudinal cross-sectional view of an upper section of an alternative embodiment of the pipe assembly of FIG. 1;

FIG. 11a is a partial longitudinal cross-sectional view of an upper section of an alternative embodiment of the pipe assembly of FIG. 1;

FIG. 11b is a partial longitudinal cross-sectional view of an upper section of an alternative embodiment of the pipe assembly of FIG. 11a;

FIG. 11b is a partial longitudinal cross-sectional view of an upper section of an alternative embodiment of the pipe assembly of FIG. 11a;

FIG. 11c is a partial longitudinal cross-sectional view of an upper section of an alternative embodiment of the pipe assembly of FIG. 11a;

FIG. 11d is a partial longitudinal cross-sectional view of an upper section of an alternative embodiment of the pipe assembly of FIG. 11a; and

FIG. 11e is a partial longitudinal cross-sectional view of an upper section of an alternative embodiment of the pipe assembly of FIG. 11a.

### DETAILED DESCRIPTION OF THE DRAWINGS

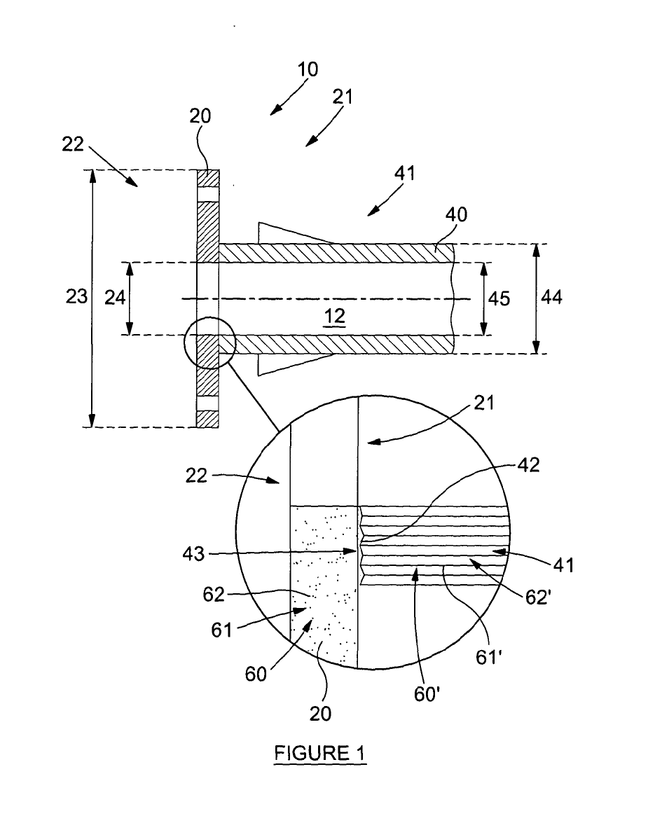

A pipe connection apparatus or assembly, generally identified by reference numeral 10, in accordance with an embodiment is shown in FIG. 1. The pipe connection apparatus 10 comprises a composite engagement member or washer 20 adapted to be placed in contact or in abutment with an end region 41 of a pipe 40. The engagement member 20 is configured to accommodate the end face or end surface 43 of the end region 41 of the pipe 40. The engagement member 20 is configured to preferentially deform to sealably contact or abut surface irregularities 42 on the end face or end surface 43 of the end region 41 of the pipe 40

The pipe connection apparatus 10 may be suitable for use in a number of applications, such as in the recovery of hydrocarbons from a subterranean reservoir. For example, the pipe may be used as a riser, flow line, jumper, coiled tubing or the like (not shown).

The pipe 40 may have any desired shape, but in this embodiment is substantially annular.

The connection apparatus 10 permits, in use, direct engagement of the pipe end 41 with the engagement member 20. By such provision, the pipe end 41 may engage with the structure (note shown) such that the end region 41 of the pipe 40 terminates proximate the structure. In this embodiment, the engagement member 20 defines an interface interposed between the pipe end 41 and the structure. By such provision, an area of connection between the pipe end 41 and the structure is reduced, and internal and/or external forces exerted on the connection apparatus 10 is reduced.

The engagement member 20 is made of a composite material 60 comprising a matrix 61 and one or more reinforcing elements 62, in this embodiment reinforcing fibres, embedded within the matrix 61. Only a small amount of the reinforcing fibres 62 is illustrated in FIG. 1 for clarity. The matrix material 61 may comprise a polymer, such as a thermoplastic polymer, and in some embodiments the matrix may comprise polyether ether ketone (PEEK). The reinforcing fibres 62 may comprise carbon fibres, glass fibres or the like.

In this embodiment, a first side 21 of the engagement member 20 is shown in contact or in abutment with an end region 41 of a pipe 40. It will be understood that a second side 22 of the engagement member 20 may also be in contact or in abutment with an end region of a further pipe, or an auxiliary member, e.g. an auxiliary piece of equipment or apparatus such as a tank, a manifold, a pump or the like.

The engagement member 20 may be provided freely from the pipe 40 and/or a structure to which the pipe 40 is to be connected. Alternatively, the engagement member may be fixed to the pipe and/or structure, for example by welding, fusing, bonding, mechanical fixing or the like.

In an alternative embodiment, there may be provided a plurality of engagement members 20, e.g. longitudinally adjacent, abutting and/or connected to each other.

The construction of the composite material 60 of the engagement member 20 selected such that at least some of the reinforcing fibres 62 may splay upon engagement with the pipe 40, e.g. may deform, bend or move within the matrix 61.

The fibres 62 of the composite material 60 of the engagement member 20 are predominantly oriented in a direction such that the engagement member 20, e.g. matrix 61 thereof, is capable of accommodating and/or sealably contacting or abutting surface irregularities 42 of the end region 41 of the pipe 40, and/or of substantially evenly applying compressive loads on the end face or end surface 43 of end region 41 of the pipe 40, without causing damage to the end region 41 of the pipe 40.

In this embodiment, the fibres 61 of the composite material 60 of the engagement member 20 are predominantly oriented in a direction substantially transverse, e.g. substantially perpendicular, to the direction of the irregularities 42.

However, in other embodiment the fibres may be provided in a random fashion, for example by being provided by chopped fibres mixed within the matrix.

In this embodiment, the fibres 61 of the composite material 60 of the engagement member 20 are predominantly oriented in a substantially circumferential direction, and the irregularities 42 of the end region 41 of the pipe 40 extend in a substantially axial direction. By such provision, the engagement member 20 may act to spread the axial compressive load on the end region 41 of the pipe 40 over most or substantially all of the end surface 43 of the pipe 40 engaged with the engagement member 20, thereby reducing the risk of failure of the pipe end 41.

Such configuration allows the irregularities 42 to “fit” or be accommodated between the lengths of fibres 62 running predominantly in a substantially transverse, e.g. substantially perpendicular direction, due to the resilient nature of the matrix 61. Thus, the fibres 62 of the composite material 60 of the engagement member 20 may be allowed or forced to splay upon engagement with the end region 41 of the pipe 40, e.g. deform, bend or move within the matrix 61. By such provision, exertion of substantial compressive loads upon the reinforcing fibres 62 in an axial direction relative to the fibre orientation may be avoided or at least reduced, thus reducing potential damage to the connected parts.

In an alternative embodiment, the fibres 62 of the composite material 60 of the engagement member 20 may be predominantly oriented in a substantially axial direction, an the irregularities 42 of the end region 41 of the pipe 40 may extend in a substantially circumferential direction.

In this embodiment, the end region 41 of the pipe 40 is made of a composite material 60′ comprising a matrix 61′ and a plurality of reinforcing fibres 62′ embedded within the matrix 61′. The surface irregularities 42 are present by virtue of the ends of fibres 61′ at or near the end surface or end face 43 of the end region 41 of the pipe 40.

In an alternative embodiment, the end region 41 of the pipe 40 may be made of a non-composite material, e.g. metal. In such instance, the surface irregularities 42 may comprise irregularities resulting from the manufacture and/or processing, e.g. cutting, of the end region 41 of the pipe 40.

The shape and/or profile of the engagement member 20 matches, e.g. is similar to, the shape and/or profile of the end region 41 of the pipe 40.

In this embodiment, the engagement member 20 and end region 41 of the pipe 40 are substantially hollow, and comprise an inner bore or lumen 12. In this embodiment, the engagement member 20 and end region 41 of the pipe 40 are substantially tubular and circular in cross-section. In an alternative embodiment, the shape and/or profile of the engagement member 20 and end region 41 of the pipe 20 may be substantially rectilinear, e.g. square, hexagonal, etc, in cross-section.

In this embodiment, the outer diameter 23 of the engagement member 20 is larger than an outer diameter 44 of the end region 41 of the pipe 40. In this embodiment, the inner diameter 24 of the engagement member 20 is substantially equal to an inner diameter 45 of the end region 41 of the pipe 40.

In this embodiment, the longitudinal thickness of the engagement member 20 is substantially uniform. In this embodiment, the end region 41 of the pipe 40 has an inner diameter of approximately 10 inches (approximately 25 cm), and an outer diameter of approximately 11 inches (approximately 28 cm).

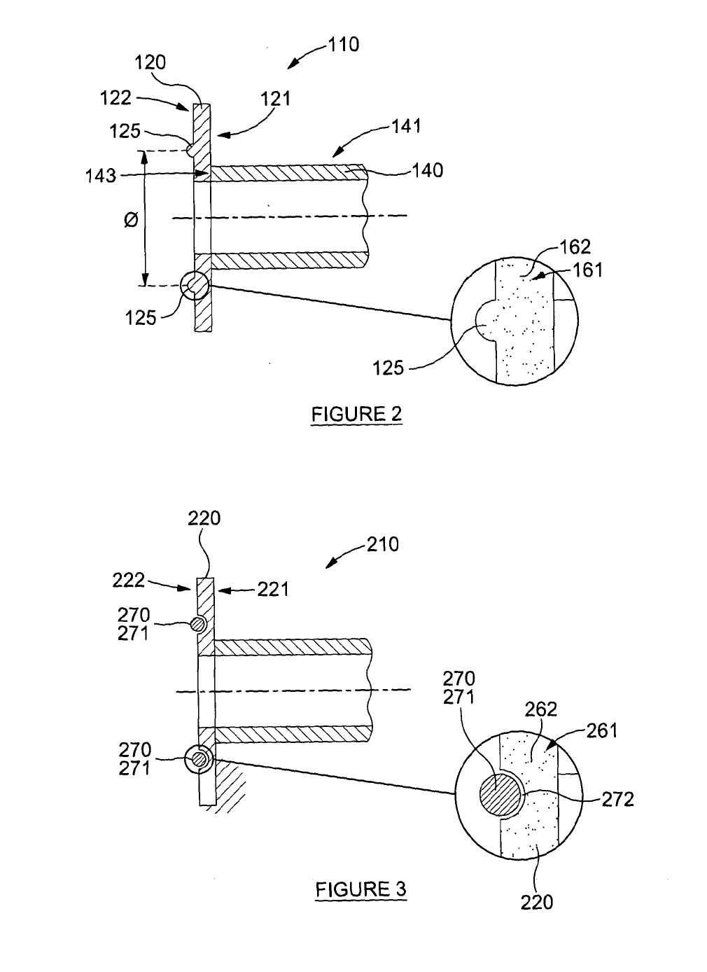

Referring now to FIG. 2, there is shown a pipe connection apparatus 110 accordingly to a second embodiment. The pipe connection apparatus 110 is generally similar to the pipe connection apparatus 10 of FIG. 1, like parts being denoted by like numerals, but incremented by “100”.

In this embodiment, the engagement member 120 comprises a dimple 125, e.g. at least one annular protrusion 125 of the engagement member 120. In this embodiment, the engagement member 120 comprises an annular dimple 125 on its second side 122 for abutting and/or contacting a structure 150 (not shown).

By such provision, the dimple 125 may provide a preferential engagement region 125 on the engagement member 120 which may act to preferentially bear high compressive loads, in use. This may be particularly desirable, e.g. if the connection apparatus 110 and/or engagement member 120 may be subject to, e.g. flexural or bending forces, in use. The dimple 125 may also act to reduce the area of the engaging surface 122 between the engagement member 120 and the further pipe and/or structure (not shown), which may be exposed to pressure, e.g. to internal pressure from within the pipe 140, and/or to external pressure from outside the pipe 140. By such provision, the force exerted on the exposed area may be minimized.

The dimple 125 also acts to distribute and/or spread loading, e.g. axial loading, preferentially, e.g. substantially evenly, between the composite pipe end 141 in contact with the first side 121 of the engagement member 120, and the structure in contact with its second side 122 when the structure is made of a more rigid material than the composite pipe end 141, e.g. a steel pipe end.

In an alternative embodiment, the engagement member 120 may comprise more than one dimple 125 on its first side 121 and/or second side 122.

In an alternative embodiment, the engagement member 120 may alternatively or additionally comprise one or more annular dimples (not shown) on its first side 121 for abutting and/or contacting the end face or end surface 143 of the end region 141 of the pipe 140.

Referring now to FIG. 3, there is shown a pipe connection assembly 210 accordingly to a third embodiment. The pipe connection assembly 210 is generally similar to the pipe connection assembly 10 of FIG. 1, like parts being denoted by like numerals, but incremented by “200”.

In this embodiment, the connection assembly 210 comprises a sealing member 270, e.g. an annular compressive seal or ‘o-ring’ 271, which fits within a recess 272 of the engagement member 220.

In this embodiment the sealing member 270 is provided on a second side 222 of the engagement member 220 for abutting and/or contacting a structure 250 (not shown). In an alternative embodiment, the engagement member 220 may alternatively or additionally comprise a sealing member 270, e.g. an annular compressive seal 271, on its first side 221 for abutting and/or contacting the end face or end surface 243 of the end region 241 of the pipe 240.

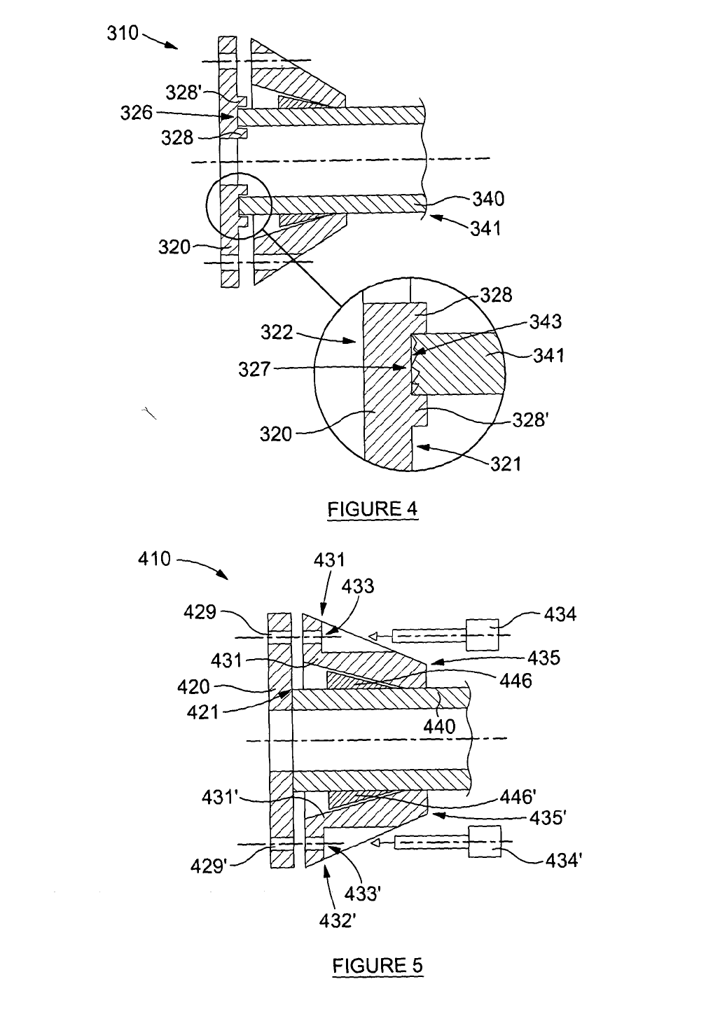

Referring now to FIG. 4, there is shown a pipe connection assembly 310 accordingly to a fourth embodiment. The pipe connection assembly 310 is generally similar to the pipe connection assembly 10 of FIG. 1, like parts being denoted by like numerals, but incremented by “300”.

In this embodiment, the engagement member 320 comprises an interengaging feature 326 on its first side 321, for receiving, interacting, or engaging with the end region 341 of the pipe 340.

In an alternative embodiment, the engagement member 320 may additionally or alternatively comprise an interengaging feature 326 on its second side 322, for receiving, interacting, or engaging with a structure (not shown).

In this embodiment, the interengaging feature 326 comprises an annular groove 327 provided between two concentric annular rims 328,328′, such that the end face or end surface 343 of the end region 341 of the pipe 340 fits within the annular groove 327.

In use, when the engagement member 320 is in contact with the pipe 340, the provision of a groove 327 defined by annular rims 328,328′ may act to prevent or at least reduce the risk of failure of the pipe end 341, by reducing the risk of splaying of fibres 362 of the composite material 360 of the pipe end 341.

In alternative embodiments, the interengaging feature 326 may take the form of e.g. a single rim, or one or more individual protrusions.

FIG. 4 also shows a connection member 330 for securing, in this embodiment, end region 341 of the pipe 340 to the engagement member 320. In this embodiment, the pipe connection apparatus 310 comprises a plurality of discrete connection members 331,331′. In an alternative embodiment, the connection apparatus 310 may comprise an annular connection members extending adjacent or around the circumference of the end region 341 of the pipe 340.

In alternative embodiments, the connection apparatus 310 may comprise one or more connection members 330 for securing, e.g., a structure (not shown) to the engagement member 320.

The connection members 331,331′ comprise an attachment portion 332,332′ in proximity with the first side 321 of the engagement member 320 and configured for securing the connection members 331,331′ to the engagement member 320.

Referring to FIG. 5, there is shown a pipe connection apparatus 410 accordingly to a fifth embodiment. The pipe connection apparatus 410 is generally similar to the pipe assembly 10 of FIG. 1, like parts being denoted by like numerals, but incremented by “400”.

The pipe connection apparatus 410 is similar to the pipe connection apparatus 310 of FIG. 4, except that the engagement member 420 does not comprise an interengaging feature. As shown in FIG. 5, connection members 431,431′ each comprise a receiving portion 433,433′ which in this embodiment is provided in the form of a hole or aperture. Receiving portions 433,433′ are arranged for receiving fixing members 434,434′ such as bolts, screws or the like.

The engagement member 420 comprise receiving portions 429,429′ which in this embodiment are provided in the form of holes or apertures. Receiving portions 429,429′ are arranged for receiving fixing members 434,434′ such as bolts, screws or the like.

In this embodiment, receiving portions 433,433′ are substantially aligned respectively with receiving portions 429,429′. By such provision, connection members 431,431′ may be secured or attached to the engagement member 420 by provision of fixing members 434,434′ such as bolts, screws or the like.

In an alternative embodiment, connection members 431,431′ may be secured or attached to the engagement member 420 by provision of clips, clamps or the like.

Connection members 431,431′ each comprise a pipe connecting portion 435,435′ which engages with the pipe 440 so as to urge and/or bias the end region 441 of the pipe 440 against a first side 421 of the engagement member 42

The end region 441 of the pipe 440 comprises anchors 446,446′ configured for engaging with or contacting respective pipe connecting portions 435,435′ of connection members 431,431′.

In this embodiment the pipe 440 comprises a plurality of discrete anchors 446,446′. In another embodiment, the pipe 440 may comprise an annular or at least partially annular anchor.

Anchors 446,446′ extend circumferentially and radially outwards from an outer surface of the pipe 440.

In this one embodiment, anchors 446,446′ are tapered, and the gradient of the taper increase from a distal region to a proximal region relative to the engagement member 420.

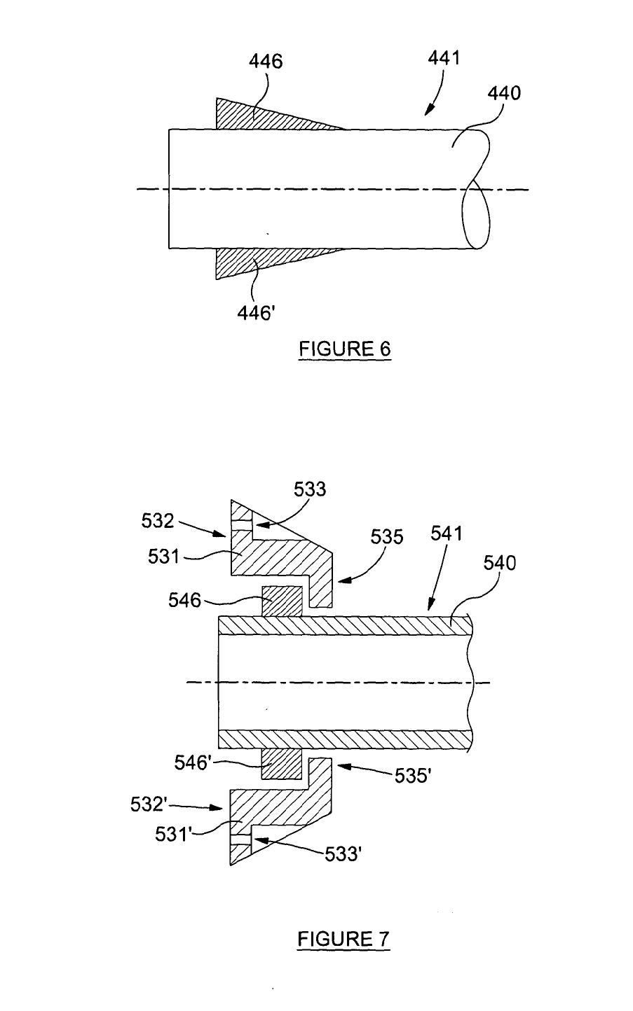

FIG. 6 shows a pipe 440 for use with the pipe connection assembly 410 of FIG. 5.

Referring now to FIG. 7, there is shown a pipe connection apparatus 510 accordingly to a sixth embodiment, without engagement member. The pipe assembly 510 is generally similar to the pipe assembly 10 of FIG. 1, like parts being denoted by like numerals, but incremented by “500”.

In this embodiment, the pipe 540 comprises anchors 546,546′ which have a substantially uniform profile in cross-section, in this embodiment, substantially square in cross-section.

The connecting portions 535,535′ of connection members 531,531′ are of a shape substantially complementary to the shape of anchors 546,546′ so as to engage with anchors 546,546′ and act to urge and/or bias the end region 541 of the pipe 540 against a first side of an engagement member (not shown).

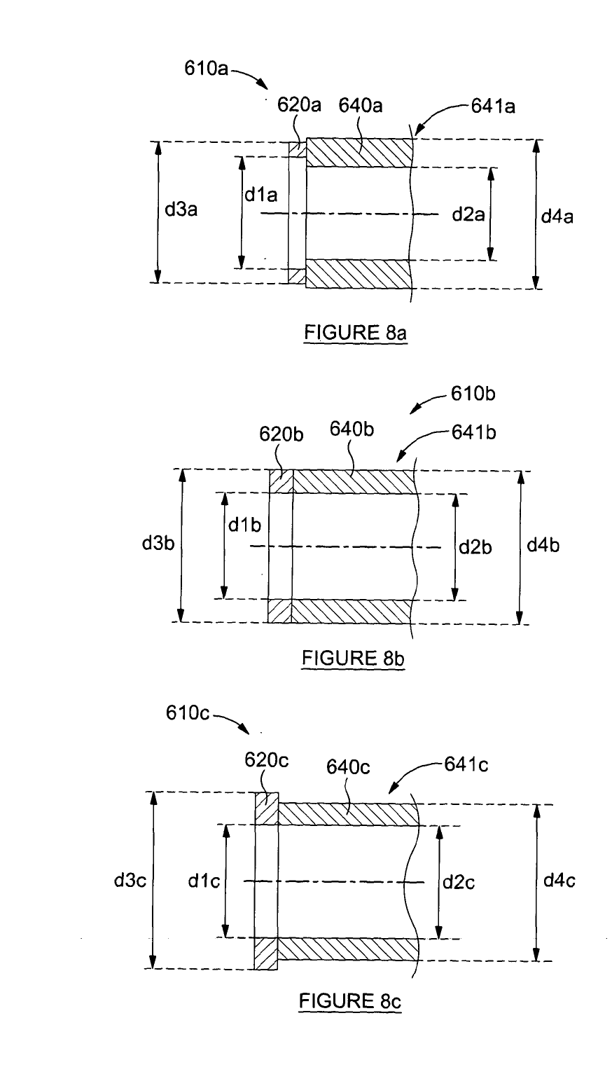

Referring now to FIG. 8a, there is shown a pipe connection apparatus 610a according to a seventh embodiment. The pipe connection apparatus 610a is generally similar to the pipe connection apparatus 10 of FIG. 1, like parts being denoted by like numerals, but incremented by “500”, and supplemented by the suffix “a”.

In this embodiment, the pipe connection apparatus 610a comprises an engagement member 620a, but not connection member.

In this embodiment, the size of the annulus of the engagement member 620a is smaller than the size of the annulus of the pipe 640a, i.e. the inner diameter d1 a of the engagement member is greater than the inner diameter d2a of the end region 641a of the pipe 640a, and the outer diameter d3a of the engagement member 641a is smaller than the outer diameter d4a of the end region 641a of the pipe 640a.

Referring now to FIG. 8b, there is shown a pipe connection apparatus 610b accordingly to an eighth embodiment. The pipe connection apparatus 610b is generally similar to the pipe connection apparatus 610a of FIG. 8a, like parts being denoted by like numerals, but supplemented by the suffix “b”.

In this embodiment, the size of the annulus of the engagement member 620b is substantially similar to the size of the annulus of the pipe 640b, i.e. the inner diameter d1b of the engagement member 610b is substantially similar to the inner diameter d2b of the end region 641b of the pipe 640b, and the outer diameter d3b of the engagement member 610b is substantially similar to the outer diameter d4b of the end region 641b of the pipe 640b.

Referring now to FIG. 8c, there is shown there is shown a pipe connection apparatus 610c accordingly to a ninth embodiment. The pipe connection apparatus 610c is generally similar to the pipe connection apparatus 610a of FIG. 8a, like parts being denoted by like numerals, but supplemented by the suffix “c”.

In this embodiment, the size of the annulus of the engagement member 620c is greater than the size of the annulus of the pipe 640c. The inner diameter d1c of the engagement member 610c is substantially similar to the inner diameter d2c of the end region 641c of the pipe 640c, and the outer diameter d3c of the engagement member 610c is greater than the outer diameter d4c of the end region 641c of the pipe 640c.

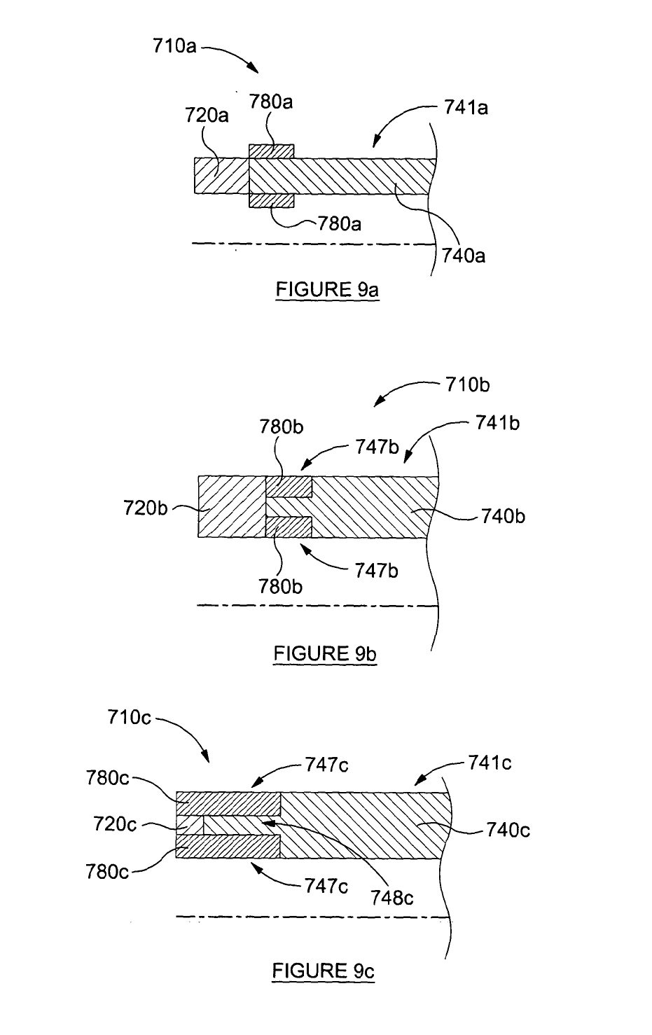

Referring now to FIG. 9a, there is shown a pipe connection apparatus 710a accordingly to a tenth embodiment. The pipe connection apparatus 710a is generally similar to the pipe connection apparatus 10 of FIG. 1, like parts being denoted by like numerals, but incremented by “600”, and supplemented by the suffix “a”.

The pipe connection apparatus 710a comprises a wrapping member 780a. In this embodiment, the wrapping member 780a is provided on an outer surface and inner surface of the end region 741a of the pipe 740a. By such provision, the risk of failure of the composite pipe end 741a due to splaying of the fibres 762a of the composite 760a material, e.g. in a substantially radial direction, is reduced.

In an alternative embodiment, the wrapping member 780a may be provided on the outer surface only of the pipe 740a, or on the inner surface only of the pipe 740a.

In this embodiment, the wrapping member 780a is provided on the outer surface and inner surface of the end region 741a of the pipe 740a prior to engagement of the pipe 740a with the engagement member 720a.

Referring now to FIG. 9b, there is shown a pipe connection apparatus 710b accordingly to an eleventh embodiment. The pipe connection apparatus 710b is generally similar to the pipe connection apparatus 710a of FIG. 9a, like parts being denoted by like numerals, but supplemented by the suffix “b”.

However, in this embodiment, the end region 741b of the pipe 740b is profiled, and comprises a recess or indent 747b on an outer surface thereof, and a recess or indent 748b on an inner surface thereof, for accommodating the wrapping member 780b. In this embodiment, the outer diameter of the wrapping member 780b is substantially similar to the outer diameter of the end region 741b of the pipe 740b and of the engagement member 720b.

Referring now to FIG. 9c, there is shown a pipe connection apparatus 710c accordingly to a twelfth embodiment. The pipe connection apparatus 710c is generally similar to the pipe connection apparatus 710b of FIG. 9b, like parts being denoted by like numerals, but supplemented by the suffix “c”.

In this embodiment, the wrapping member 780c portion is provided on the outer and the inner surface both of a protrusion 748b on the end portion 741c of the pipe 740c, and of the engagement member 720c.

This may be achieved by providing engagement member 720c on the end of the protrusion 748c of the pipe 740c having a recess or indent 748b thereon, then providing the wrapping member 780c, or by providing engagement member 720c on the end 741c of the pipe 740c, creating a recess or indent 748c on the pipe end 741c and the engagement member 720c, then providing the wrapping member 780c on or within the recess or indent 748c.

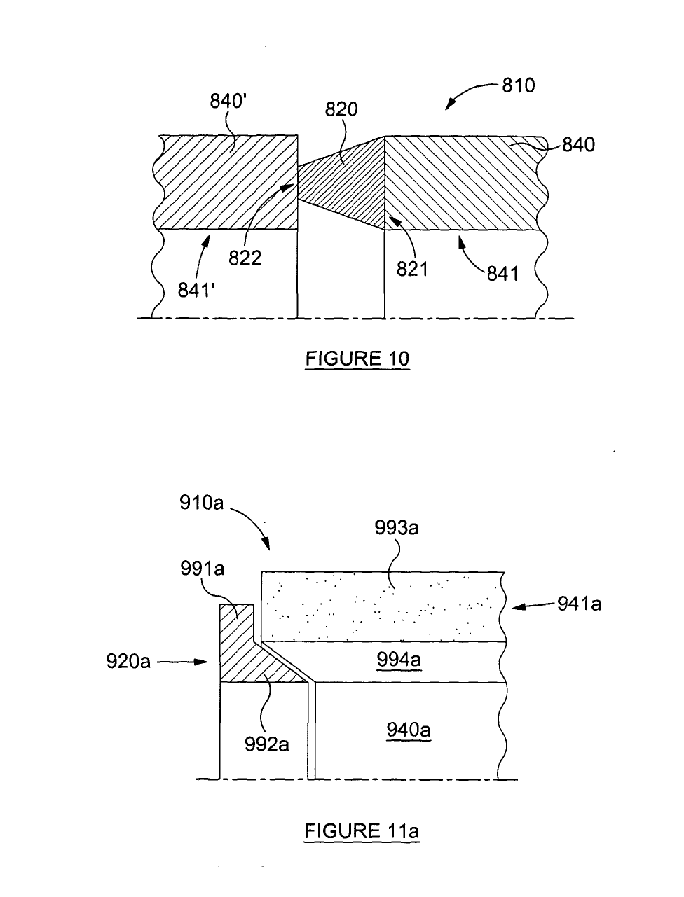

Referring now to FIG. 10, there is shown a pipe connection apparatus 810 accordingly to a thirteenth embodiment. The pipe connection apparatus 810 is generally similar to the pipe connection apparatus 10 of FIG. 1, like parts being denoted by like numerals, but incremented by “800”.

The pipe connection apparatus 810 comprises an engagement member 820 interposed between en end region 841 of a composite pipe 840, and an end region 841′ of a steel pipe 840′.

The elasticity of the composite pipe 840 is greater than the elasticity of the steel pipe 840′. In this embodiment, in order to distribute and/or spread axial loading, preferentially, e.g. substantially evenly, between the composite pipe end 841 and the steel pipe end 841′, or at least reduce the axial loading on the composite pipe end 841, the engagement member 820 is profiled such that the area of engagement with the composite pipe end 841 on its first side 821 is smaller than the area of engagement with the steel pipe end 841′ on its second side 822.

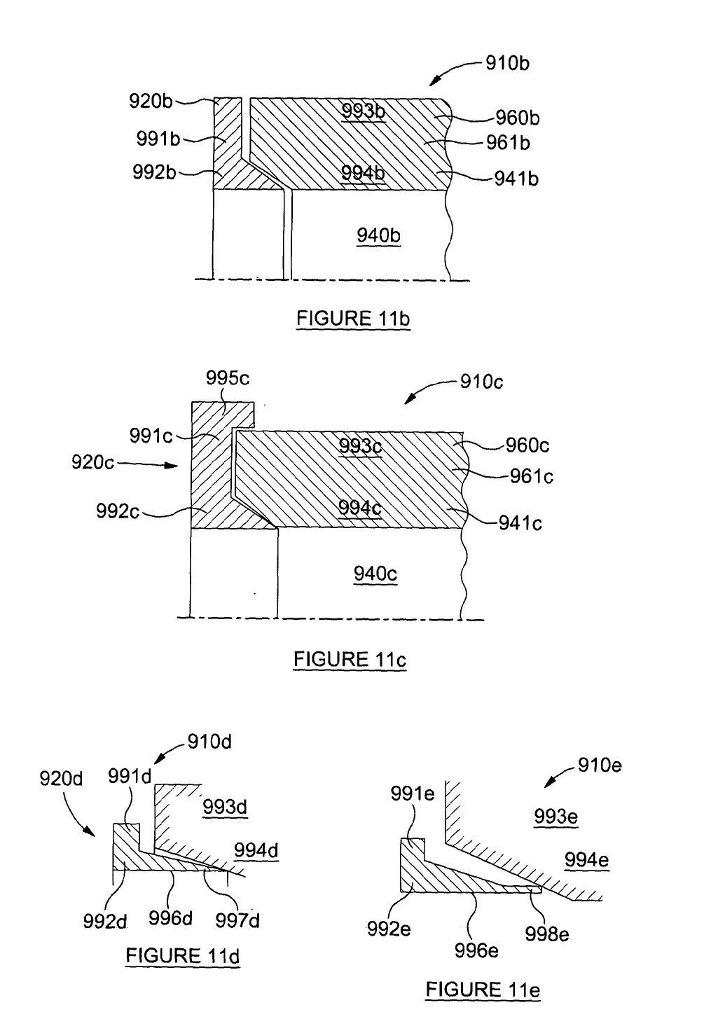

Referring now to FIG. 11a, there is shown a pipe connection apparatus 910a accordingly to a fourteenth embodiment. The pipe connection apparatus 910a is generally similar to the pipe connection apparatus 10 of FIG. 1, like parts being denoted by like numerals, but incremented by “900”, and supplemented by the suffix “a”.

The pipe connection apparatus 910a comprises an engagement member 920a in proximity, contact or abutment with an end region 941a of pipe 940a.

The engagement member 920a comprises a straight portion 991a near an outer region thereof, and a profiled portion 992a near an inner region thereof.

The profiled portion 992a is tapered so as to extend towards the end region 941a of the pipe 940a, and has a thickness greater than the thickness of the straight portion 991a.

The pipe end 941a comprises an outer portion 993a and an inner portion 994a. In this embodiment, the outer portion 993a is made of a composite material, and the inner portion is made of a non-composite material, in this embodiment PEEK.

In alternative embodiments, such as those of FIGS. 11b and 11c below, both the outer portion 993a and inner portion 994a may be made of a composite material.

The end region of the outer portion 993a is substantially complementary with the straight portion 991a of the engagement member 920a. In this embodiment, the straight portion 991a of the engagement member 920a extends partially proximal or against the end region of the outer portion 993a.

The end region of the inner portion 994a is substantially complementary with the profiled portion 992a of the engagement member 920a. By such provision, in use, internal pressure from within the pipe 940a acts to compress the inner profiled portion 992a of the engagement member 920a against the inner portion 994a of the pipe end 941a, which helps increasing sealing performance with the pipe end 941a at or near an inner diameter thereof. Because the inner portion 994a of the pipe end 941a comprises a polymeric material such as polyether ether ketone (PEEK), the inner portion 994a of the pipe 940a is capable of complying and/or deforming upon contact with the inner profiled portion 992a of the engagement member 920a so as to further improve sealing performance near an inner diameter of the pipe end 941a.

It will be appreciated that in another embodiment, e.g. when outer pressures from outside the pipe are dominant, the engagement member 920a may comprise an outer profiled portion similar to inner profiled portion 992a, but tapered from a central portion of the engagement member 920a towards an outermost portion thereof.

Referring now to FIG. 11b, there is shown a pipe connection apparatus 910b accordingly to a fifteenth embodiment. The pipe connection apparatus 910b is generally similar to the pipe connection apparatus 910a of FIG. 11a, like parts being denoted by like numerals, but supplemented by the suffix “b”.

However, in this embodiment, the straight portion 991b of the engagement member 920b extends proximal or against substantially the whole of the outer portion 993b of the pipe end 941b.

In this embodiment, both the inner portion 994b and the outer portion 993b the pipe end 941b comprise a composite material 960b. In such instance, the inner profiled portion 992b also acts to prevent or at least reduce the risk of failure of the pipe end 941a through decompaction of the composite structure and/or splaying of fibres, e.g. in a substantially radial direction, at or near inner portion 994b of the pipe 940b due to substantial compressive loads, e.g. substantial local compressive loads, causing structural disintegration and/or decompaction of the composite material 960a and/or breakdown of the polymer matrix 961a.

Referring now to FIG. 11c, there is shown a pipe connection apparatus 910c accordingly to a sixteenth embodiment. The pipe connection apparatus 910c is generally similar to the pipe connection apparatus 910b of FIG. 11b, like parts being denoted by like numerals, but supplemented by the suffix “c”.

However, in this embodiment, the engagement member 920c comprises an outer substantially annular rim 995c near an outer region thereof. The outer substantially annular rim 995c acts to prevent or at least reduce the risk of failure of the outer portion 993c of the pipe end 941c through decompaction of the composite structure and/or splaying of fibres, e.g. in a substantially radial direction, at or near an outer end region 941c of the pipe 940c due to substantial compressive loads, e.g. substantial local compressive loads, causing structural disintegration and/or decompaction of the composite material 960c and/or breakdown of the polymer matrix 961c. The outer substantially annular rim 995c is substantially similar in construction as the annular rim 328′ of the interengaging feature 326 of FIG. 4.

Referring now to FIG. 11d, there is shown a pipe connection apparatus 910d accordingly to a seventeenth embodiment. The pipe connection apparatus 910d is generally similar to the pipe connection apparatus 910a of FIG. 11a, like parts being denoted by like numerals, but supplemented by the suffix “d”.

However, in this embodiment, both the inner portion 994d and the outer portion 993d the pipe end 941d comprise a composite material 960d.

In this embodiment, the inner profiled portion 992d is configured such that, in use, a tip end 997d of a an innermost portion 996d of the inner profiled portion 992d first contacts the inner region 994d of the pipe end 941d. By such provision, the innermost portion 996d of the inner profiled portion 992d may act as a preferential seal with the pipe end 941d, because the elastic recovery of the engagement member 920d will be highest at or near the innermost portion 996d of the inner profiled portion 992d. In such instance, the inner profiled portion 992d first contacts the pipe end 941d near an inner diameter thereof. In use, upon further engagement with the pipe 940d, the inner profiled portion 992d will deform so as to allow full engagement of the engagement member 920d with the pipe end 941d.

Referring now to FIG. 11e, there is shown a pipe connection apparatus 910e accordingly to an eighteenth embodiment. The pipe connection apparatus 910e is generally similar to the pipe connection apparatus 910d of FIG. 11d, like parts being denoted by like numerals, but supplemented by the suffix “e”.

However, in this embodiment, the innermost portion 996e of the inner profiled portion 992e comprises a flat ended tip end 998e instead of the pointed tip end 997e of the embodiment of FIG. 11d. Like in the embodiment of FIG. 11d, in use, upon further engagement with the pipe 940e, the inner profiled portion 992e will deform so as to allow full engagement of the engagement member 920e with the pipe end 941e.

1. A pipe connection apparatus comprising a washer member to be engaged with an end region of a pipe and be interposed between the end region of the pipe and a structure to which said pipe is connected, wherein at least part of the washer member comprises a composite material formed of at least a matrix and one or more reinforcing elements embedded within the matrix, and the construction of the composite material of the washer member permits the washer member to deform to accommodate the end region of the pipe when said pipe is connected to the structure.

2. A pipe connection apparatus according to claim 1, wherein the washer member is configured to contact or abut an end face region of the pipe.

3. A pipe connection apparatus according to claim 1, wherein deformation of the washer member accommodates preferential load distribution within the end portion of the pipe.

4. A pipe connection apparatus according to claim 1, wherein the washer member is configured to spread axial loading on the end region of the pipe over an end surface of the pipe engaged with the washer member.

5. A pipe connection apparatus according to claim 1, wherein the composite material of the washer member is deformable so as to accommodate surface irregularities of the end region of the pipe.

6. A pipe connection apparatus according to claim 1, wherein the matrix material is deformable upon connection of the pipe to the structure.

7. A pipe connection apparatus according to claim 1, wherein at least some of the reinforcing elements are configured to splay within the matrix.

8. A pipe connection apparatus according to claim 1, wherein the washer member is provided freely and is secured against the pipe when said pipe is connected to the structure.

9. A pipe connection apparatus according to claim 1, wherein the washer member is fixed to one or both of the pipe and the structure.

11. A pipe connection apparatus according to claim 1, wherein at least some of the reinforcing elements of the composite material of the washer member are provided in a random manner within the matrix material.

12. A pipe connection apparatus according to claim 1, wherein at least some of the reinforcing elements of the composite material of the washer member are provided in an ordered manner with a global or predominant direction of alignment within the matrix material.

13. A pipe connection apparatus according to claim 1, wherein at least some of the reinforcing elements of the composite material of the washer member are predominantly oriented in a direction substantially orthogonal to a longitudinal axis of the pipe and/or substantially orthogonal to a predominant direction of orientation of reinforcing elements of a composite material of the pipe end.

14. A pipe connection apparatus according to claim 1, wherein at least some of the reinforcing elements of the composite material of the washer member are predominantly oriented in a substantially circumferential direction.

15. A pipe connection apparatus according to claim 1, wherein at least part of the end region of the pipe comprises a composite material comprising a matrix and one or more reinforcing elements embedded within the matrix.

16. A pipe connection apparatus according to claim 1, wherein the one or more reinforcing elements of the composite material of the washer member is selected from reinforcing fibres and/or nanotubes.

17. A pipe connection apparatus according to claim 1, wherein the washer member is substantially annular.

18. A pipe connection apparatus according to claim 1, wherein the type and/or distribution of the reinforcing elements is homogeneous throughout at least a portion of the matrix of the washer member.

19. A pipe connection apparatus according to claim 1, wherein the type and/or distribution of the reinforcing elements varies throughout at least a portion of the matrix of the washer member.

20. A pipe connection apparatus according to claim 1, wherein the washer member is configured to distribute axial loading preferentially between the pipe end in contact with a first side of the washer member and the structure in contact with a second side of the washer member.

21. A pipe connection apparatus according to claim 1, wherein the distribution of the reinforcing elements varies throughout the matrix in an axial direction through an axial thickness of the washer member.

22. A pipe connection apparatus according to claim 1, wherein the type and/or the mechanical properties of the reinforcing elements varies throughout the matrix in an axial direction through an axial thickness of the washer member.

23. A pipe connection apparatus according to claim 1, wherein the washer member is profiled such that the area of engagement with the pipe end on a first side is different from the area of engagement with the structure on a second side.

24. A pipe connection apparatus according to claim 23, wherein the washer member is tapered from its first side to its second side.

25. A pipe connection apparatus according to claim 1, wherein the washer member comprises at least one interengaging feature for receiving and/or engaging with the end region of the pipe.

26. A pipe connection apparatus according to claim 25, wherein the at least one interengaging feature comprises one or more rims configured to engage with, contain, contact or abut an inner and/or an outer circumference of the end region of the pipe.

27. A pipe connection apparatus according to claim 1, comprising at least one wrapping portion provided on an outer and/or inner surface of the end region of the pipe.

28. A pipe connection apparatus according to claim 27, wherein an outer and/or inner surface of the end region of the pipe and/or washer member is configured for accommodating the wrapping portion

29. A pipe connection apparatus according to claim 27, wherein the wrapping portion comprises a composite material formed of at least a matrix and one or more reinforcing elements embedded within the matrix.

30. A pipe connection apparatus according to claim 29, wherein the one or more fibres of the composite material of the wrapping portion are predominantly oriented in a substantially circumferential direction.

31. A pipe connection apparatus according to claim 1, wherein the washer member comprises at least one sealing member provided on a first and/or second side thereof.

32. A pipe connection apparatus according to claim 31, wherein the at least one sealing member comprises a compressive seal.

33. A pipe connection apparatus according to claim 1, wherein the washer member is configured to substantially reduce or restrict an area of the engaging surface between the washer member and the pipe, which is exposed to an internal pressure from within the pipe and/or to an external pressure from outside the pipe.

34. A pipe connection apparatus according to claim 1, wherein the washer member comprises at least one protrusion extending outwardly relative to a first side and/or a second side of the washer member.

35. A pipe connection apparatus according to claim 34, wherein at least one protrusion is provided near an inner diameter or perimeter of the washer member and/or near an outer diameter or perimeter of the washer member.

36. A pipe connection apparatus according to claim 1, wherein a first and/or second side of the washer member comprises a profiled portion near an inner region and/or an outer region of the washer member.

37. A pipe connection apparatus according to claim 36, wherein the profiled portion extends from a non-profiled portion of the washer member towards an innermost or an outermost portion of the washer member.

38. A pipe connection apparatus according to claim 36, wherein a thickness of the profiled portion is greater than a thickness of the washer member in a non-profiled portion thereof.

39. A pipe connection apparatus according to claim 36, wherein the profiled portion comprises an inner profiled portion configured such that, in use, an innermost portion of the inner profiled portion first contacts an inner region of the pipe end/structure.

40. A pipe connection apparatus according to claim 36, wherein the profiled portion comprises an outer profiled portion configured such that, in use, an outermost portion of the outer profiled portion first contacts an outer region of the pipe end/structure.

41. A pipe connection apparatus according to claim 39, wherein, in use, upon further engagement with the pipe/structure, the inner and/or outer profiled portion deforms so as to allow full engagement of the washer member with the pipe end/structure.

42. A pipe connection apparatus according to claim 1, wherein the pipe connection apparatus comprises at least one first connection member for securing an end region of the pipe to the washer member, to at least one further washer member, to the structure, and/or to at least one second connection member.

43. A pipe connection apparatus according to claim 1, wherein the pipe connection apparatus comprises at least one second connection member for securing the structure to the washer member, to at least one further washer member, to an end region of the pipe, and/or to at least one first connection member.

44. A pipe connection apparatus according to claim 42, wherein the at least one first and/or second connection member is configured to urge and/or bias the end region of the pipe against the washer member.

45. A pipe connection apparatus according to claim 42, wherein the pipe comprises at least one first anchor configured for engaging with or contacting a pipe connecting portion of the at least one first connection member.

46. A pipe connection apparatus according to claim 42, wherein the structure comprises at least one second anchor configured for engaging with or contacting a pipe connecting portion of the at least one second connection member.

47. A pipe connection apparatus according to claim 42, wherein the at least one first and/or second anchor comprises a raised portion which extends circumferentially and/or radially outwards from an outer surface of respectively the pipe and/or the structure.

48. A pipe connection apparatus according to claim 47, wherein the at least one first and/or at least one second anchor is tapered.

49. A pipe connection apparatus according to claim 1, configured to permit, in use, engagement of the pipe with the structure such that the end region of the pipe terminates proximate the structure.

51. A pipe connection apparatus according to claim 1, wherein the structure to which the pipe is or is to be connected comprises a further pipe, equipment selected from the list of a container, a tank, a manifold, and/or a pump, at least part or all of the washer member, and/or one or more further washer members.

58. A washer member to be engaged with an end region of a pipe and be interposed between the end region of the pipe and a structure to which said pipe is connected, wherein the washer member comprises a composite material formed of at least a matrix and one or more reinforcing elements embedded within the matrix, and the construction of the composite material of the washer member permits the washer member to deform to accommodate the end region of the pipe when said pipe is connected to the structure.

60. A pipe assembly comprising:
a pipe comprising an end region; and
a connection apparatus comprising a washer member engaged with the end region of the pipe and arranged to become interposed between the end region of the pipe and a structure to which said pipe is connected, wherein the washer member comprises a composite material formed of at least a matrix and one or more reinforcing elements embedded within the matrix, and the construction of the composite material of the washer member permits the washer member to deform to accommodate the end region of the pipe when said pipe is connected to the structure.

62. A method of connecting an end region of a pipe to a structure, comprising interposing a washer member between an end region of a pipe and a structure, wherein the washer member comprises a composite material formed of at least a matrix and one or more reinforcing elements embedded within the matrix, and the construction of the composite material of the washer member permits the washer member to deform to accommodate the end region of the pipe when the pipe is connected to the structure.

63. The pipe assembly according to claim 60, wherein at least the end region of the pipe comprises a composite material comprising a matrix and a plurality of reinforcing elements embedded within the matrix, wherein at least some of the reinforcing elements of the composite material of the pipe extend in a substantially axial direction.

64. The pipe assembly according to claim 63, wherein the end region of the pipe comprises terminating ends of a plurality of reinforcing elements which extend in a substantially axial direction of the pipe.

65. The pipe assembly according to claim 63, wherein the matrix material of the washer member is deformable to permit at least some of the reinforcing elements contained therein to splay.

66. A pipe connection apparatus comprising a washer member to be engaged with an end region of a pipe and be interposed between the end region of the pipe and a structure to which said pipe is connected, wherein the washer member is deformable to accommodate the end region of the pipe when said pipe is connected to the structure.

67. The pipe connection apparatus according to claim 66, wherein the washer member comprises PEEK.

68. The pipe connection apparatus according to claim 66, wherein the pipe comprises a composite material comprising a matrix material and one or more reinforcing fibres embedded within the matrix material.

69. The pipe assembly according to claim 68, wherein at least some of the reinforcing elements of the composite material in the end region of the pipe extend in a substantially axial direction.

70. The pipe assembly according to claim 68, wherein the end region of the pipe comprises terminating ends of a plurality of reinforcing elements which extend in a substantially axial direction of the pipe.

71. The pipe connection apparatus according to claim 68, wherein the matrix material comprises PEEK.
